(19) United States
(12) Patent Application Publication
(10) Pub. No.: US 2026/0084049 A1
(43) Pub. Date: Mar. 26, 2026

(54) GAME SYSTEM, STORAGE MEDIUM, SERVER, AND GAME PROCESSING METHOD

(71) Applicant: NINTENDO CO., LTD., Kyoto (JP)

(72) Inventors: Tsubasa SAKAGUCHI, Kyoto (JP); Masaki WADA, Kyoto (JP); Keishi ASA, Kyoto (JP); Tadashi SAKAMOTO, Kyoto (JP)

(21) Appl. No.: 19/332,549

(22) Filed: Sep. 18, 2025

(30) Foreign Application Priority Data
Sep. 20, 2024 (JP) 2024-163840

(51) Int. Cl. A63F 13/35

(52) U.S. Cl. CPC A63F 13/35

(57) ABSTRACT

When the sum of the number of accounts that are participating in a game session as an operator and the number of accounts that are participating in the game session as a viewer satisfies a condition, at least one of the accounts that are participating in the game session as the viewer is caused to exit the game session, and transmission of game information to an information processing terminal related to the exited account is stopped.

### CROSS REFERENCE TO RELATED APPLICATION

This application claims priority to Japanese Patent Application No. 2024-163840, filed on Sep. 20, 2024, the entire contents of which are incorporated herein by reference.

### FIELD

The technology disclosed herein relates to game systems, storage media, servers, and game processing methods that execute a process using a virtual space.

### BACKGROUND AND SUMMARY

There has conventionally been a game system in which a game player that is playing an online game can be spectated by other players.

In such a game system, when the number of game players and the number of spectating players increase, the server can determine which of the players should be allowed to participate in a game.

The present example discloses a game system, storage medium, server, and game processing method that are capable of determining which user is to participate in a session according to priority or the like.

The present example may have the following features (1) to (15), for example.

(1) An example configuration of a game system according to the present example is a game system comprising: at least one server configured to manage a game session; and a plurality of information processing terminals configured to connect to the server. Accounts related to the respective information processing terminals are caused to participate in the game session, and a game is played between the accounts. The server is configured to, in response to a participation request received from the information processing terminal, cause the account related to the information processing terminal to participate in the game session as at least one of an operator that operates a player object related to the account in the game and a viewer that at least views an in-game content in the game, transmit game information about a state of the game to the information processing terminal related to the account that is participating in the game session, and update the game information based on update information received from the information processing terminal. A first information processing terminal of the plurality of information processing terminals is configured to transmit, to the server, data including a first account related to the first information processing terminal as a first participation request for participation in the game session as the operator, based on a first operation input of a user, based on a second operation input for designating an in-game content included in one of a plurality of the game sessions, transmit, to the server, data including the first account as a second participation request for participation as the viewer in the game session including the in-game content, when the first account is participating in the game session as the operator, generate a game space including a first player object related to the first account, based on the game information, perform first virtual camera control to control a virtual camera in the game space, based on a position of the first player object, and transmit, to the server, the update information based on the state of the game space, and when the first account is participating in the game session as the viewer, generate a game space including the in-game content designated by the second operation input, based on the game information, update a state of the in-game content based on the game information, and perform second virtual camera control to control the virtual camera in the game space, based on a position of the in-game content designated by the second operation input. The server is further configured to, when the sum of the number of accounts that are participating in the game session as the operator and the number of accounts that are participating in the game session as the viewer satisfies a condition, cause at least one of the accounts that are participating in the game session as the viewer to exit the game session, and stop transmitting the game information to the information processing terminal related to the exited account.

With the configuration of (1), when the number of operators that are operating a player object and participating in the game session and the number of viewers that are viewing an in-game content and participating in the game session increase, selection of an account(s) that is to be caused to participate in the game session is managed. Therefore, an account(s) that is to be caused to participate in the game session can be determined based on the order of priority.

(2) In the configuration of (1), the server may be further configured to, in response to reception of the first participation request from a second account related to a second information processing terminal of the plurality of information processing terminals, cause the second account to participate in the game session as the operator. The first information processing terminal may be configured to, based on the second operation input of a user designating the second account or a second player object related to the second account, transmit, to the server, the second participation request for participation as the viewer in the game session including the second player object.

With the configuration of (2), the first account can be caused to participate in the game session as a viewer that views the second player object related to the second account.

(3) In the configuration of (1) or (2), the server may be further configured to manage a first and a second game session of the plurality of game sessions. The management of the second game session may include causing the first account to participate in the second game session as the viewer in response to reception of the second participation request for participation in the second game session as the viewer from the first account participating in the first game session as the operator. The management of the first game session may include causing the first account to participate in the first game session as the operator in response to reception of the first participation request for participation in the first game session as the operator from the first account participating in the second game session as the viewer.

With the configuration of (3), the first account can be caused to switch from the operator of the first game session to the viewer of the second game session and participate in the second game session.

(4) In the configuration of (3), the management of the first game session may further include storing the number of the accounts that are participating in the first game session as the operator and the number of the accounts that are participating in the first game session as the viewer, and not reducing the number of the accounts that are participating in the first game session as the operator in response to participation of the account that has been participating in the first game session as the operator, in the second game session as the viewer.

With the configuration of (4), it is possible to prevent the situation that the condition is satisfied while an account is temporarily participating in another game session as the viewer, so that the account is not allowed to return to an original game session as the operator.

(5) In the configuration of (4), the management of the first game session may further include reducing the number of the accounts that are participating in the first game session as the operator in response to passage of a period of time after participation of the first account in the second game session as the viewer.

With the configuration of (5), the participation capacity of the game session can be prevented from being filled for a long period of time without participation as the operator.

(6) In the configuration of any one of (3) to (5), the first information processing terminal may be further configured to, when the first account participates in the second game session as the viewer from the first game session in which the first account has been participating as the operator, dispose a first object having an appearance different from that of the first player object at a position based on a position of the first player object in the game space in the first game session, and transmit, to the server, the update information including first object position information about the position of the first object, and when a second account related to a second information processing terminal of the plurality of information processing terminals participates in the first game session as the operator, generate the game space including the first object at a position based on the object position information.

With the configuration of (6), that an account is participating as the viewer can be recognized by another account.

(7) In the configuration of (6), the first information processing terminal may be further configured to, when the first account participates in the first game session as the operator from the second game session in which the first account has been participating as the viewer, generate the game space in which the first player object is disposed at a position based on the first object position information instead of the first object.

With the configuration of (7), when the first object is caused to return as the operator by being disposed in the game space, the first player object can be caused to return to a position where the first player object had been disposed before the first player object participated as the viewer.

(8) In the configuration of (6) or (7), the second information processing terminal may be further configured to limit changing of a state of the first object based on the user's operation input.

With the configuration of (8), a position to which the first player object is caused to return can be prevented from being changed during participation as the viewer.

(9) In the configuration of (3), the management of the first game session may include causing the first account to participate in the first game session as the operator when the management of the second game session causes the first account to exit the second game session based on satisfaction of the condition by the second game session after causing the first account to participate in the second game session as the viewer.

With the configuration of (9), when an account is caused to exit a game session in which the account has been participating as the viewer, the account can be caused to return to and participate in a game session in which the account had been participating as the operator.

(10) In the configuration of any one of (1) to (9), the server may be further configured to, when the condition is satisfied, determine the account that is to exit the game session, based on the length of a period of time that has passed since the participation as the viewer in the game session for which the condition is satisfied.

With the configuration of (10), when a viewer is caused to exit the game session, the viewer that is caused to exit can be selected based on a period of time during which spectating has been performed.

(11) In the configuration of any one of (1) to (10), the first information processing terminal may be configured to, when the first account is participating in the first game session as the operator, dispose a second object in the game space based on the user's third operation input, and transmit, to the server, the update information including second object position information about a position of the second object. The server may be further configured to store the first account as a disposer in association with the first game session based on reception of the update information including the second object position information, and when the first game session satisfies the condition due to reception of the second participation request for participation in the first game session as the viewer from the first information processing terminal related to the first account stored as the disposer, cause the account that is not stored as the disposer and is participating in the first game session as the viewer to exit the first game session.

With the configuration of (11), an account that has already disposed the second object in the game space in the game session can be caused to participate in the game session as the viewer with higher priority.

(12) In the configuration of any one of (1) to (11), the first information processing terminal may be configured to, when the first account is participating as the operator in a first game session of the plurality of game sessions, dispose a second object in the game space based on the user's third operation input, and transmit, to the server, the update information including second object position information about a position of the second object, and when the first account is participating in the first game session as the viewer in response to the user's second operation input for designating the second object, transmit, to the server, the first participation request for participation in the first game session as the operator in response to the user's fourth operation input. The server may be configured to cause the first account to participate in the first game session as the operator in response to the first participation request transmitted in response to the fourth operation input.

With the configuration of (12), when an account that has already disposed the second object in the game space in the game session is viewing the second object, the user's operation for participation in the game session as the operator can be determined.

(13) In the configuration of any one of (1) to (12), the first information processing terminal may be configured to, when the first account is participating in the first game session as the operator, dispose a second object in the game space based on the user's third operation input, and transmit, to the server, the update information including second object position information about a position of the second object. A second information processing terminal of the plurality of information processing terminals may be configured to, when a second account related to the second information processing terminal participates in the first game session as the operator, transmit, to the server, the second participation request for participation as the viewer in a game session in which the first account is participating as the operator, based on the user's fifth operation input with respect to the second object.

With the configuration of (13), participation as the viewer in the game session in which an account that has disposed the second object in the game space is participating can be easily performed.

(14) In the configuration of any one of (1) to (12), the first information processing terminal may be configured to, when the first account is participating in the first game session as the operator, dispose a second object in the game space based on the user's third operation input, and transmit, to the server, the update information including second object position information about a position of the second object. A second information processing terminal of the plurality of information processing terminals may be configured to, when a second account related to the second information processing terminal participates in the first game session as the operator, obtain an item related to the second object based on the user's fifth operation input with respect to the second object, and transmit, to the server, the second participation request for participation as the viewer in a game session in which the first account is participating as the operator, based on the user's sixth operation input for using the obtained item.

With the configuration of (14), an item that can be used to easily make a participation request for participation as the viewer in the game session in which an account has disposed the second object in the game space is participating can be held.

(15) In the configuration of any one of (1) to (14), the first information processing terminal may be further configured to transmit, to the server, the second participation request for designating a second account related to a second information processing terminal of the plurality of information processing terminals. The server may be configured to, when the second account is participating as the viewer in a third game session of the plurality of game sessions, cause the first account to participate in the third game session as the viewer in response to the second participation request.

With the configuration of (15), when an account to be viewed is participating in another game session as the viewer, participation in the another game session as the viewer can be allowed.

Furthermore, the present example may be carried out in the forms of a storage medium, server, and game processing method.

According to the present example, an account that is to be caused to participate in a game session can be determined based on the order of priority or the like.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a block diagram illustrating a non-limiting example configuration of an information processing system,

FIG. 9 is a block diagram illustrating a non-limiting example configuration of a server 102,

FIG. 10 is a diagram illustrating a non-limiting example of a game image showing a plurality of player characters PC disposed in the same game space,

FIG. 11 is a diagram showing a non-limiting example of generation of a terrain object L1 obtained by moving and arranging a plurality of terrain objects in a game space,

FIG. 12 is a diagram showing a non-limiting example of a displayed terrain object La edited to be a single mass,

FIG. 13 is a diagram illustrating a game image showing a non-limiting example of a first stage of a first player character PC1's action of disposing a first region setting object A1 in a game space,

FIG. 14 is a diagram illustrating a game image showing a second stage of a first player character PC1's action of disposing a first region setting object A1 in a game space,

FIG. 15 is a diagram illustrating a non-limiting example of a first region R1 that is set when a first region setting object A1 is set in a game space,

FIG. 16 is a diagram illustrating a non-limiting example of a shape of a first region R1,

FIG. 17 is a diagram showing a non-limiting example of a section information image displayed on a display 12,

FIG. 18 is a diagram showing a non-limiting example of a game image showing that a player character PC1 has entered a section A,

FIG. 19 is a diagram showing a non-limiting example of a game image showing that a stay piece OBJp1 is disposed in a section A,

FIG. 20 is a diagram showing a non-limiting example of a game image showing that a first user is spectating, as a viewer, a region setting object A1 in a section B.

FIG. 21 is a diagram showing an example of a game image showing that a first user is spectating, as a viewer, a player character PC3 in a section C,

FIG. 22 is a diagram showing a non-limiting example of a game image that is displayed when a user corresponding to an object to be spectated is a viewer of another object to be spectated,

FIG. 23 is a diagram showing a non-limiting example of a capacity condition of each section,

FIG. 24 is a diagram showing a non-limiting example of transition of the number of participants in each of sections A and B,

FIG. 25 is a diagram illustrating a non-limiting example of a data area set in a DRAM 85 of a game system 1,

FIG. 26 is a flowchart illustrating a non-limiting example of a game process that is executed in a game system 1,

FIG. 27 is a subroutine showing a non-limiting example of a player character control process in step S124 of FIG. 26,

FIG. 28 is a subroutine showing a non-limiting example of a spectating mode transition process in step S146 of FIG. 27,

FIG. 29 is a subroutine showing a non-limiting example of a stay section movement process in step S148 of FIG. 27,

FIG. 30 is a subroutine showing a non-limiting example of a spectating mode process in step S151 of FIG. 27,

FIG. 31 is a subroutine showing a non-limiting example of a spectating section movement process in step S187 of FIG. 30,

FIG. 32 is a subroutine showing a non-limiting example of a stay mode transition process in step S190 of FIG. 30,

FIG. 33 is a subroutine showing a non-limiting example of an other-player character control process in step S124 of FIG. 26,

FIG. 34 is a diagram illustrating a non-limiting example of a data area that is set in a storage section 105 of a server 102,

FIG. 35 is a flowchart illustrating a non-limiting example of a first half of a process executed in a server 102, and

FIG. 36 is a flowchart illustrating a non-limiting example of a second half of a process executed in a server 102.

### DETAILED DESCRIPTION OF NON-LIMITING EXAMPLE EMBODIMENTS

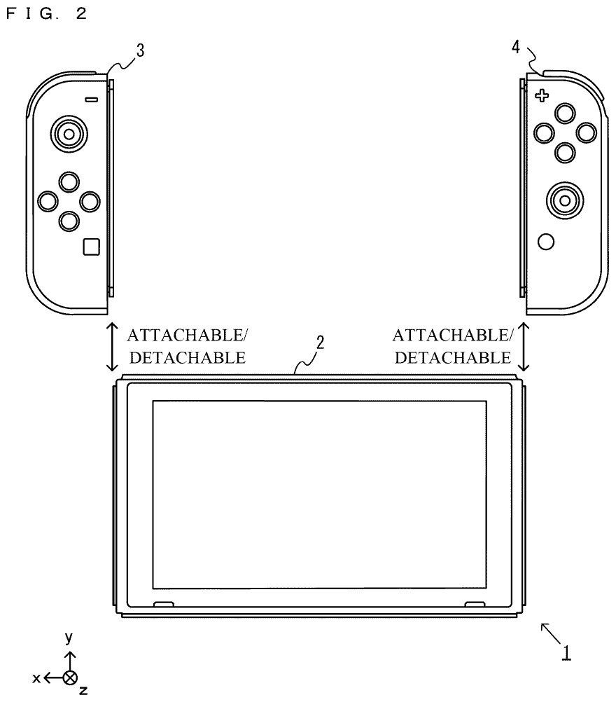

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

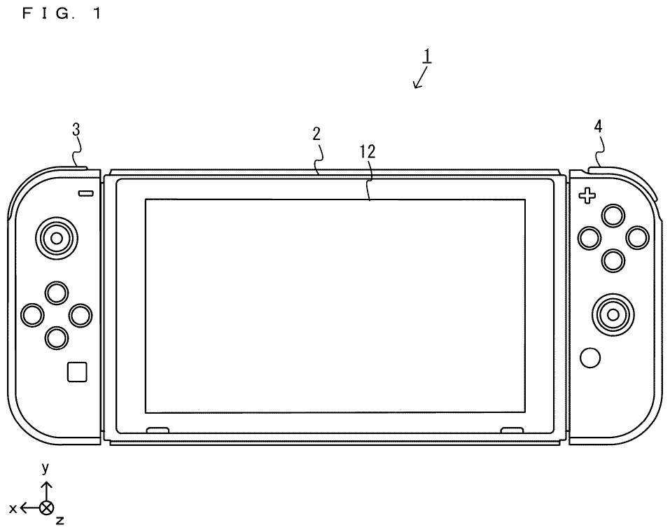

As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

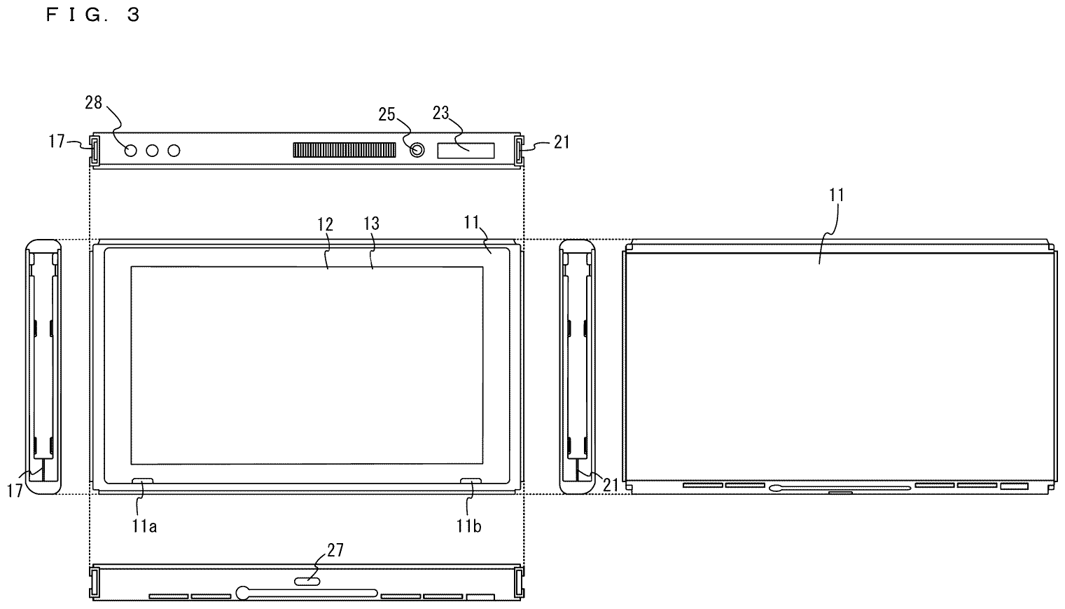

As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

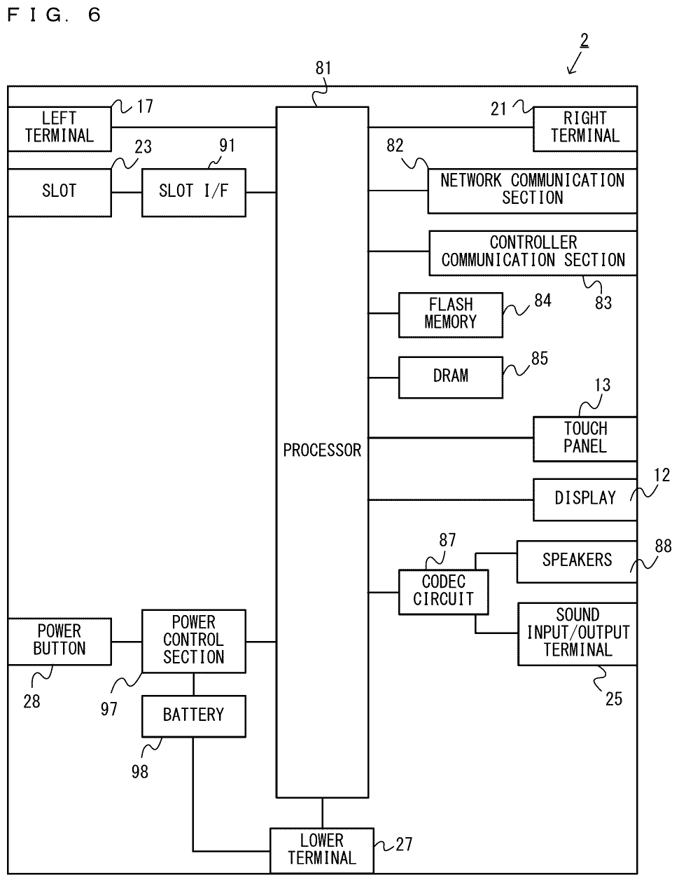

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

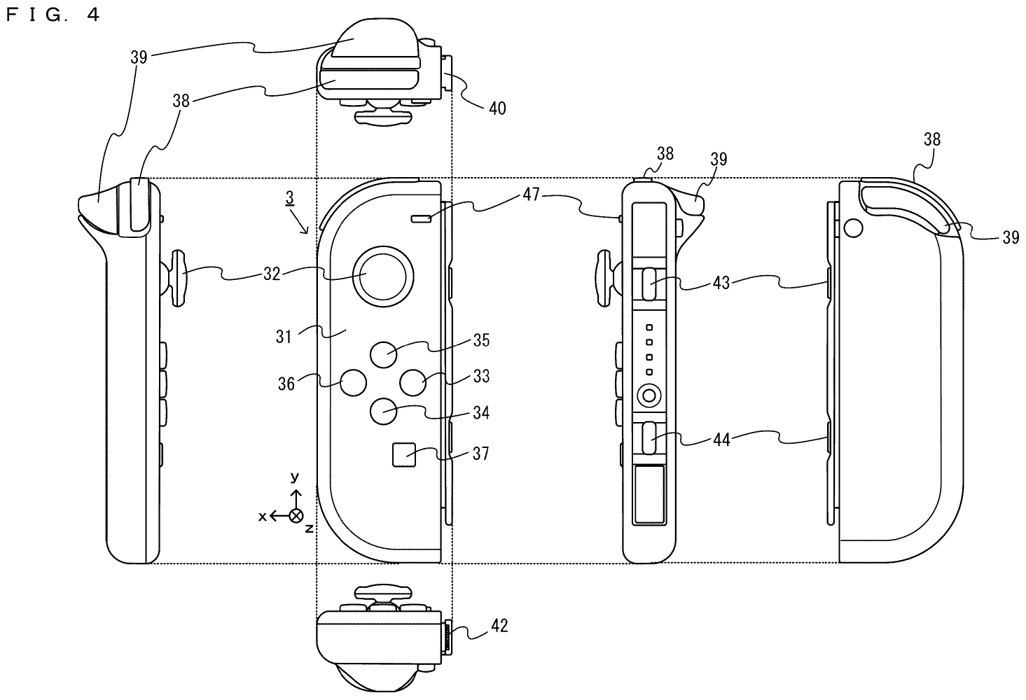

As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

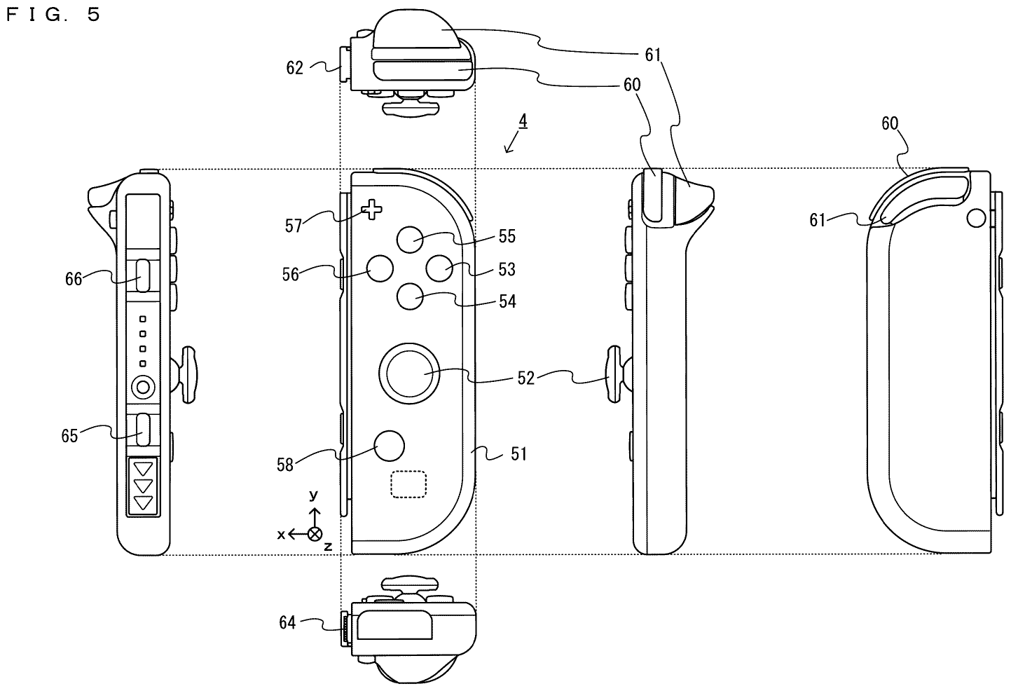

As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may only include a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to provisionally store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi (registered trademark) standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to social data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

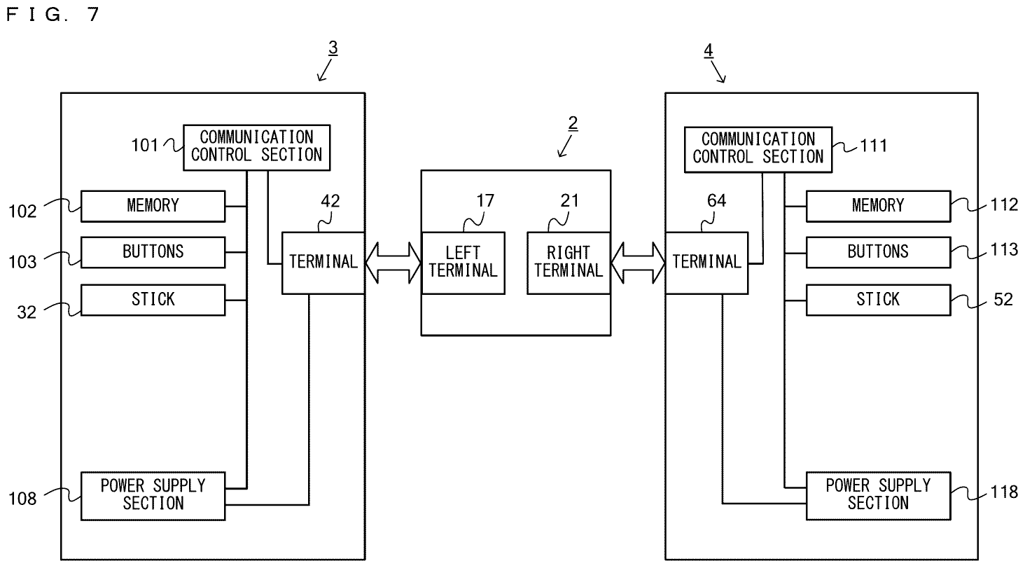

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a game space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs actions in the game space according to the user's operation performed using the operation buttons and sticks.

In the present example, a game in which a plurality of users are allowed to operate respective corresponding player characters so that the player characters perform actions in the same game space can be executed. The game is implemented by a plurality of users utilizing systems in a plurality of forms. As a first example, a game is implemented by a plurality of users operating respective player characters using respective game systems 1, and utilizing an information processing system (e.g., an information processing system in which a plurality of main body apparatuses 2 communicate with each other through a network) in which the network communication section 82 of each game system 1 performs communication through a network using the first communication form. As a second example, a game is implemented by a plurality of users operating respective player characters using respective game systems 1, and utilizing an information processing system (e.g., an information processing system in which a plurality of main body apparatuses 2 directly communicate with each other) in which the network communication section 82 of each game system 1 performs direct communication using the second communication form. As a third example, a game is implemented by inputting operation data produced by a plurality of users operating the left controller 3 and/or the right controller 4 into a single main body apparatus 2, and controlling each user's player character in the same game space using the single main body apparatus 2. In the present example, although, a system having any of the embodiments may be used, an example in which a game is implemented using an information processing system of the first example is used below.

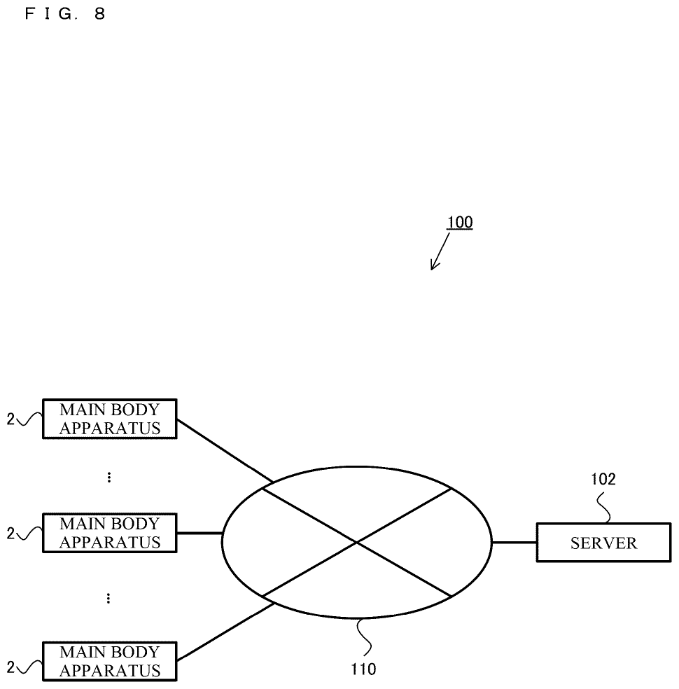

An information processing system of the first example that includes a plurality of game systems 1 and the server 102 will be described with reference to FIG. 8.

As illustrated in FIG. 8, the plurality of game systems 1 (main body apparatuses 2) and the server 102 are connected together through a network 110 to form an information processing system 100. The game system 1 is configured to be able to connect to the network 110 by the above first communication form using wireless or wired communication, and together with the server 102, forms a client-server system. For example, the game system 1 can execute a predetermined application (e.g., a game application). In addition, by executing the predetermined application, the game system 1 can establish connection to the server 102 through the network 110 and communicate with the server 102 through the network 110.

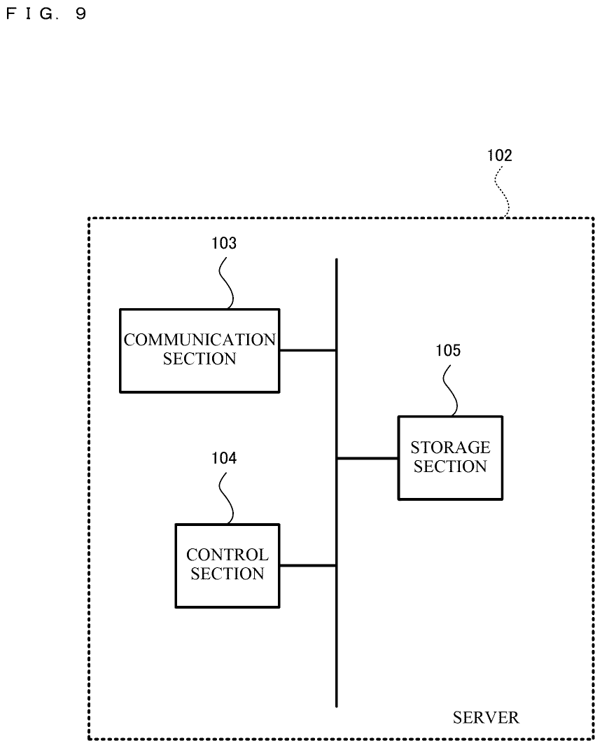

As shown in FIG. 9, the server 102 has a communication section 103, a control section 104, and a storage section 105. The communication section 103 communicates with the game systems 1 and the like through the network 110 by transmitting and receiving communication packets. As an example, the control section 104 performs a process of managing progression of a game played along with the game systems 1, a process of managing a game space used in a game, a process of managing the number of users participating in a game session (e.g., a section described below) used in a game, and the maximum number of participants (capacity), a process of managing each user's score, a process of managing information about payment or charging, and the like. The control section 104 also establishes a communication link to the game systems 1 and the like through the communication section 103, and performs data transmission control and routing on the network 110. In addition, when a game is played along with a plurality of game systems 1 (e.g., a game in which a plurality of users operate respective corresponding player characters so that the player characters perform actions in the same game space), the control section 104 manages pairing or grouping of game systems 1 that perform the game, and data communication between the game systems 1. The storage section 105 stores a program executed by the control section 104, various types of data required for the process, various types of data required for communication with the game systems 1, and the like. It should be noted that, in the case of a system in which a predetermined log-in process is required for data exchange performed through the network or joining a game, the server may execute an authentication process to determine whether or not a user who is trying to log in is an authorized user. In addition, the server may be a single server machine or may include a plurality of server machines. In the former case, the data storage area of the server 102 may be divided into physical server resource portions that are each used to manage the respective game session. In the latter case, the server 102 includes server machines each of which manages the respective game session.

In the present example, in the information processing system 100, the game systems 1 exchange operation information through the server 102, so that a networked game in which player characters corresponding to respective users perform actions in the same game space as a shared space is played. The operation information exchanged in the networked game may be information about player characters operated by the users using controllers, information about a game space edited by the player characters' actions, details of operations themselves performed by the users operating the player characters using controllers, or other information with which game progression in the game systems 1 can be understood.

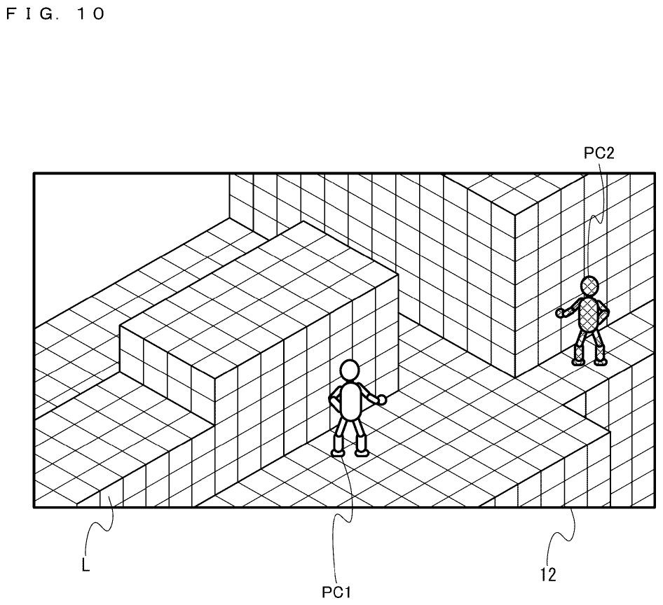

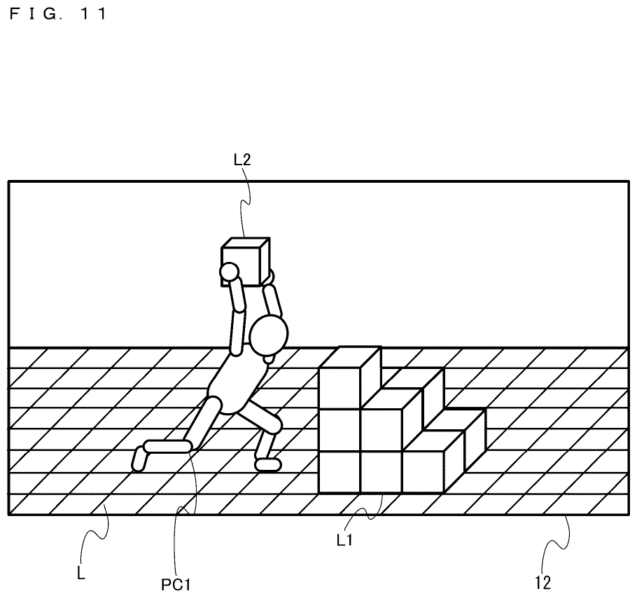

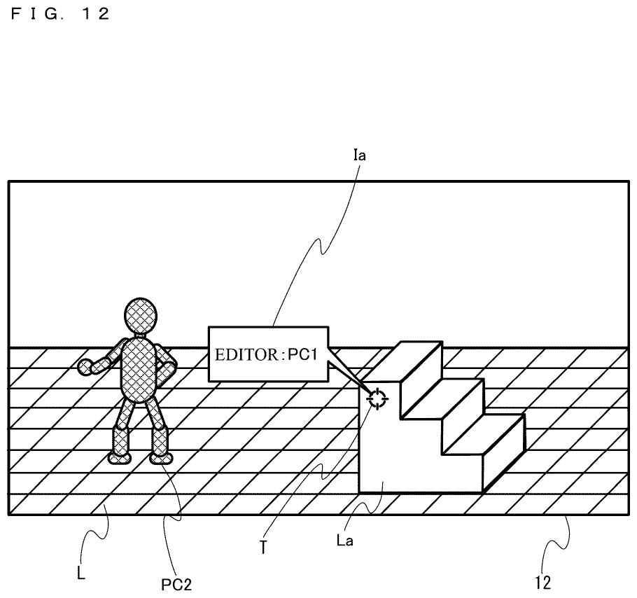

An example game process performed in the game systems 1 included in the information processing system 100 will be outlined with reference to FIGS. 10 to 24. Firstly, in the overview of the example game process, a game space used in the example game process will be outlined with reference to FIG. 10.

In FIG. 10, in the present example, a game field is constituted by a plurality of unit regions. For example, the unit regions are obtained by dividing the game field into squares disposed in a grid pattern as viewed vertically from above. The unit regions have equal sizes. Specifically, in the case in which an x-axis and a z-axis, which are horizontal and orthogonal to each other, and a y-axis, which is vertical, are set in the game field, the game field is divided by a plurality of planes parallel to the xy plane and a plurality of planes parallel to the yz plane into squares in a grid pattern, each of which is a unit region. Thus, in the game field, unit regions are disposed side by side in the horizontal direction (specifically, the front-back direction and the left-right direction) in the game space.

A shape of the game field is determined using terrain objects L (pieces) as units. Terrain objects L are elements constituting the game field. The shape of the game field can be changed by performing edition such as movement, addition, removal, or the like on a terrain object L by terrain object L basis. A size of a terrain object L in the horizontal direction of the game space is equal to that of a unit region, and a length of a terrain object L in the vertical direction of the game space is equal to a length of a unit region in the horizontal direction of the game space.

A terrain object L has a rectangular cuboid shape (more specifically, a cubic shape). A game field is constituted by terrain objects L disposed in a grid pattern in the game space. As an example, in the present example, in the game system 1, a parameter related to a terrain object L is set for a coordinate point set in the game space, and for each of a plurality of coordinate points, a parameter indicating whether or not a terrain object L exists at that coordinate point is stored. Thus, in the game system 1, a shape constituted by a plurality of terrain objects L in the game space can be specified by managing whether or not a terrain object L exists at each coordinate point in the game space (i.e., storing the parameter for each coordinate point). It should be noted that the surface of the terrain object L may have roughness, and may have a rounded corner.

In another example, in the game system 1, a parameter may be set for each terrain object L existing in the game space. The parameter set for each terrain object L indicates at least the position of the terrain object L in the game space. Thus, in the game system 1, by managing the position of each terrain object L in the game space (i.e., storing the parameter for each terrain object L), a shape constituted by a plurality of terrain objects L in the game space (the shape of a game field) can be specified.

In the present example, a terrain object can be edited such that a state of the terrain object is updated, by the player character PC performing a predetermined action based on the user's operation, for example. Examples of the updating of a state of a terrain object include disposition of a new terrain object in the game space, removal of a terrain object that has already been disposed in the game space, changing of an appearance (texture or shape) of a terrain object that has already been provided in the game space, and embedding of information in a terrain object that has already been disposed in the game space.

The editing of a terrain object includes generation of a new terrain object that appears in the game space by moving and joining terrain objects L that have been disposed in the game space together or newly moving and joining terrain objects together. The editing of a terrain object also includes updating of the generated terrain object by moving the generated terrain object, changing the appearance or property of the generated terrain object, or newly joining another terrain object to the terrain object, and the like. In the present example, a player character PC that has edited a terrain object is referred to as an “editor”.

In addition, in the present example, other objects different from terrain objects L may be disposed in the game space. In addition, the above other objects may be able to be edited based on the player character PC's predetermined action in the game space. In that case, for the above other objects, the parameters corresponding to each object may include data indicating the editor. As an example of the above other objects, a decorative object that is a content which the player character PC can wear or be equipped with in the game space can be edited based on the player character PC's predetermined action.

A terrain object may be able to be joined to another neighboring terrain object, so that an integrated terrain object is edited. For example, by the player character PC performing a predetermined action, a plurality of terrain objects that are a target of the action may be joined together to be integrated.

In the present example, a game in which a plurality of users operate and move respective corresponding player characters PC is performed using a game space constituted by a plurality of terrain objects L. For example, in the example of FIG. 10, a first player character PC1 and a second player character PC2 are disposed on a terrain constituted by a plurality of terrain objects L. The first player character PC1 corresponds to a user of a game system 1 (hereinafter referred to as a first user), and is operated in the game space by the first user's operation of the left controller 3 and/or the right controller 4 of the game system 1. The second player character PC2 corresponds to a user of another game system 1 (hereinafter referred to as a second user), and is operated in the same game space in which the first player character is disposed, by the second user's operation of the left controller 3 and/or the right controller 4 of the second user's game system 1.

A plurality of users are each allowed to change a state of the game space by operating a corresponding player character PC to edit a terrain object, which is an example of a content in the game space. For example, by causing the first player character PC1 to perform an action based on the first user's operation input, a terrain object L corresponding to a position in the game space corresponding to the action can be moved or removed, a terrain object can be newly disposed at a position in the game space corresponding to the action, or a generated terrain object can be duplicated. In addition, by causing the second player character PC2 to perform an action based on the second user's operation input, a state of the same game space can be changed in a manner similar to that for the first player character PC1.

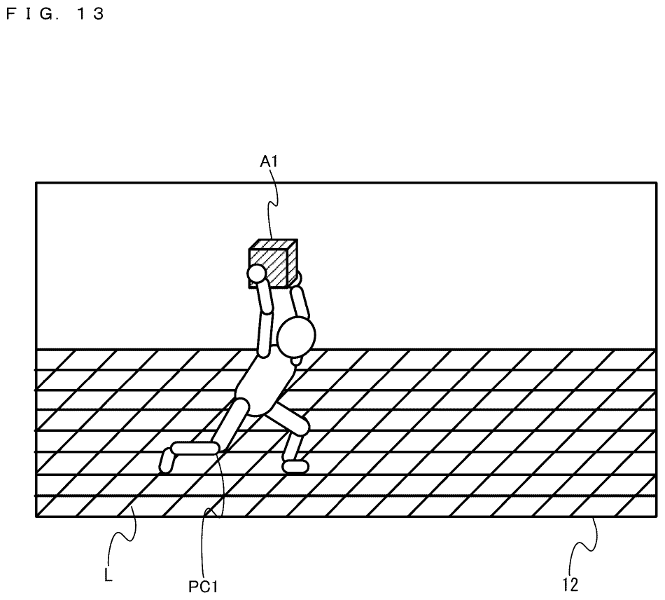

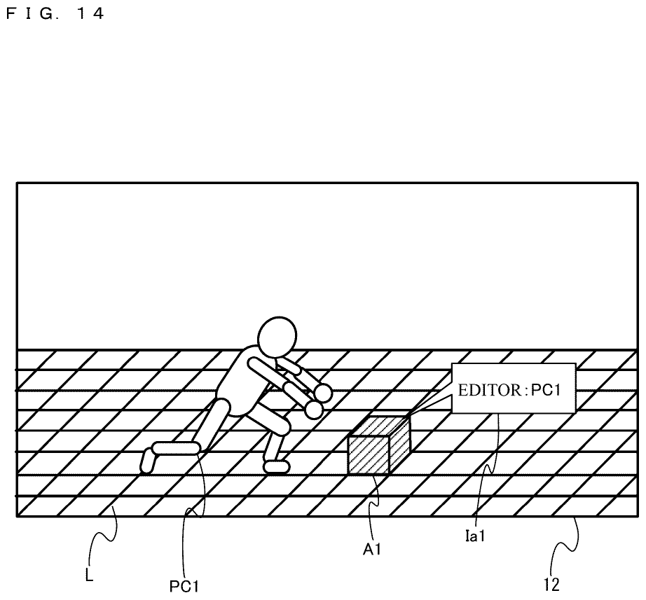

In addition, in the present example, a state in the game space can be changed and edited by executing at least one of disposition, movement, and removal of a particular object different from terrain objects L. An example in which the inside of a game space is changed using a region setting object that is an example of the particular object will be described below with reference to FIGS. 13 and 14.

In FIG. 13, the first player character PC1 is disposed on a ground surface (terrain object L) in the game space, holding the first region setting object A1 with the hands thereof. The first region setting object A1 can be lifted up and moved, or stored by the first player character PC1 performing a predetermined acquisition action (e.g., an action of lifting up or storing the first region setting object A1 disposed in the game space). When the first player character PC1 moves in the game space with the first region setting object A1 lifted up or stored, the first region setting object A1 is moved together with the first player character PC1. In addition, when the first player character PC1 pushes the first region setting object A1 on a ground (terrain object L) in the game space to move the first region setting object A1 in the pushing direction in the game space, the first region setting object A1 may be moved together with the first player character PC1.

It should be noted that the first region setting object A1 may be previously disposed in the game space (on terrain objects L) during the start of a game, or may be disposed at a predetermined position when a player level reaches a predetermined level or a predetermined acquisition condition is satisfied, e.g., a mission is achieved, or may be disposed when another character drops the first region setting object A1, or another character is beaten. The first region setting object A1 may be obtained from an object that is not a region setting object. In addition, a particular object may be changed to the first region setting object A1 when a particular action is performed on a particular object.

In FIG. 14, the first player character PC1 performs a disposition action of placing or throwing the first region setting object A1 carried by the first player character PC1 according to the first user's action instruction operation input. As a result, the first region setting object A1 is disposed at a position on a terrain object L included in a ground surface in the game space based on the disposition action according to the user's operation input, with reference to the position of the first player character PC1. As an example, when the first player character PC1 performs a disposition action of placing the first region setting object A1 carried by the first player character PC1, the first region setting object A1 is placed and disposed in contact with a terrain object L that is disposed immediately in front of the first player character PC1. As another example, when the first player character PC1 performs a disposition action of throwing the first region setting object A1 carried by the first player character PC1, the first region setting object A1 is thrown and disposed in contact with a terrain object L that is disposed at a position that is a predetermined distance (corresponding to a predetermined number of terrain objects L) away from the first player character PC1 in the front direction of the first player character PC1.

In the present example, users involved in a social activity between player characters PC (uses operating player characters PC) are given social data (e.g., “like”) based on the social activity. For example, when a user (first user) is recognized as having performed any action on another user (second user), social data are given to the second user. In this case, social data may be automatically given to the second user according to an action of a player character PC operated by the first user, or social data may be given to the second user in response to the first user's operation. It should be noted that objects that can be given social data include other player characters, region setting objects, edited terrain object, and stay pieces described below. Even when a user involved with these in-game contents is in any play situation, interaction with the user can be achieved.

The first region setting object A1 is at least one object that is associated with the first player character PC1. The first region setting object A1 has the function of, when the first region setting object A1 is disposed in a game space, setting a first region R1 associated with the first player character PC1 in the game space. Here, the association with the first player character PC1 refers to a state in which only the first player character PC1, which is one of a plurality of player characters, is allowed to use, or is given an effect. It should be noted that as described below, the first region R1 may be displayed in a display form that allows the first region R1 to be distinguished from other regions in the game space. In addition, in the present example, region information indicating a user region (e.g., the first region R1) set in the game space by the user and user information indicating the user that has set the user region (e.g., the first user that operates the first player character PC1) are managed in association with each other. Here, the region information includes the ID of a region setting object (e.g., the first region setting object A1), coordinate information of the region setting object in the game space, and the like. In another example, the region information may be related to the range itself of the user region, instead of the region setting object. In addition, the user information includes information such as the account ID, user name, and the like of the user. Although the first region setting object A1 has been described as an object associated with the first player character PC1, this has the same meaning as that the first region setting object A1 is associated with the first user that operates the first player character PC1 (more specifically, a game account, or the user ID of the first user that is the identifier assigned to the user). In that case, the first region setting object A1 can be said to have the function of setting the first region R1 associated with the first user in the game space. Here, the association with the first user is, for example, a state in which of a plurality of users, only the first user is allowed to change a parameter or use the first region R1, or is given an effect.

In the present example, editing of the game space is limited in the first region R1, except for editing of the game space that is performed by the first player character PC1. For example, as described above, each player character PC is allowed to edit a terrain object L in the game space. However, in the first region R1, editing that is performed by characters (including other player characters PC, such as the second player character PC2) other than the first player character PC1, for which the first region R1 has been set, is limited, and the right to edit the game space is given to the first player character PC1.

Thus, by an editing right related to the game space in the first region R1 being given to the first player character PC1, a limitation is imposed on other users' changing the state of the game space in the first region R1 when the first region setting object A1 is disposed or the state of the game space in the first region R1 after having been most recently changed according to the first user's operation input. Here, the limitation on changing the state of the game space is not limited to a limitation on changing based on other users' operations, and may include a limitation on changing performed by characters (e.g., non-player characters) automatically controlled by a computer, and changing caused by phenomena other than characters' actions in the game space (collapse, deterioration, or the like due to an environment such as weather or shaking, and the like).

The first region setting object A1 may also serve as the address of a present or message that is given to the first user by another user. For example, when another user sends, to the first user, an UGC (User Generated Content) object, such as an object, an object containing text, an object containing an image, and an object containing audio, the UGC object is disposed in the game space in the vicinity of the first region setting object A1 set by the first user.

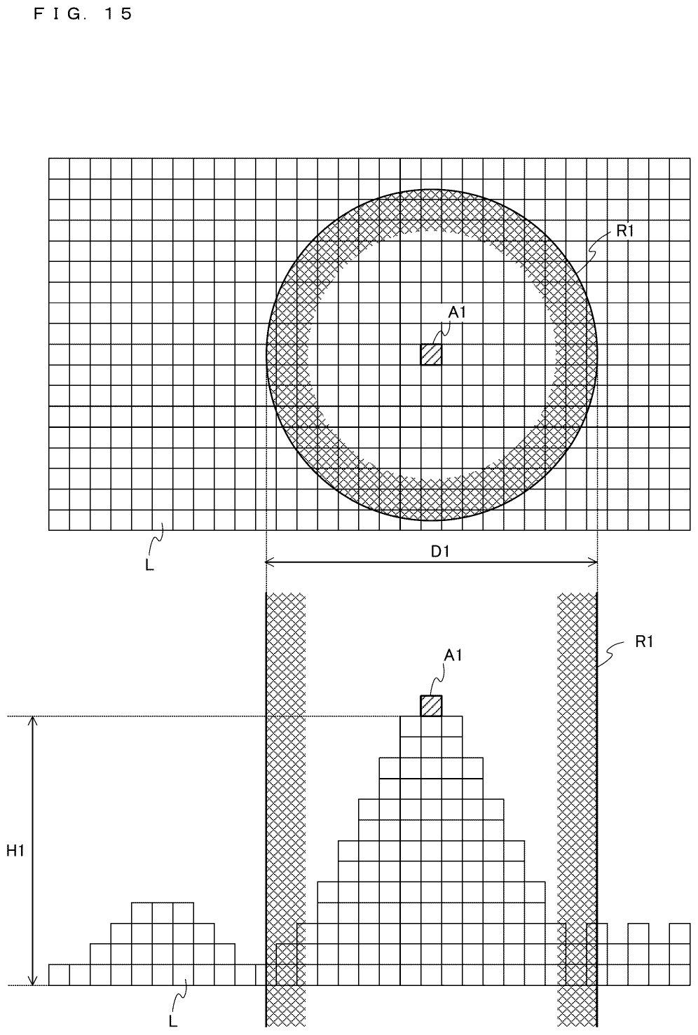

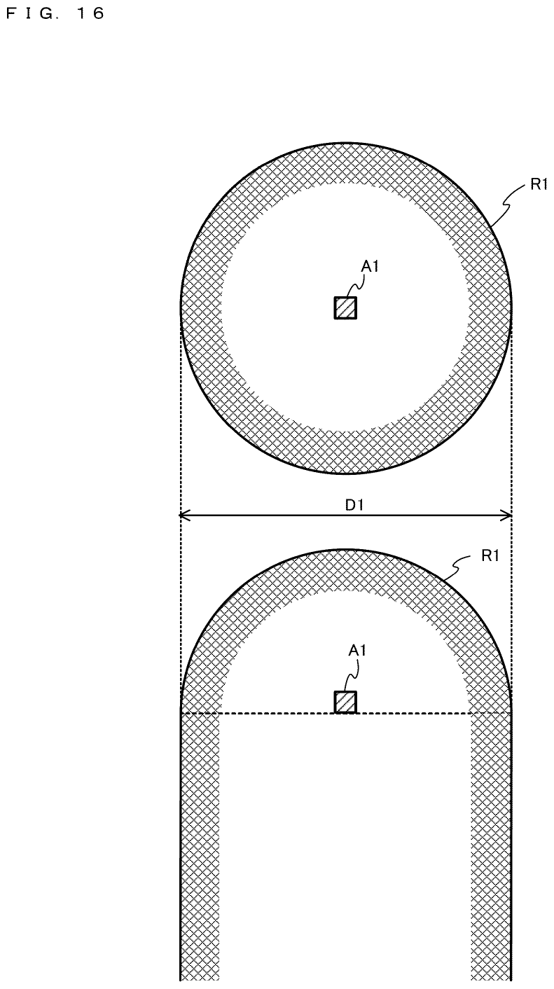

Next, an example of the position, shape, and size of the first region R1 set by disposing the first region setting object A1 in the game space will be described with reference to FIGS. 15 and 16. It should be noted that the upper diagram in each of FIGS. 15 and 16 is a top view of the first region setting object A1 and the first region R1 in the game space as viewed from above, and the lower diagram is a side view of the first region setting object A1 and the first region R1 in the game space as viewed in the horizontal direction.

As illustrated in FIG. 15, the first region R1 is set as a region including a position related to the horizontal direction of the first region setting object A1, and in the case in which a three-dimensional game space is set, is also set so as to include at least a portion of the first region setting object A1 disposed in the game space as viewed from above in the game space. Here, that at least a portion of the first region setting object A1 disposed in the game space is included as viewed from above in the game space means that at least a space in the game space in which the first region setting object A1 is located, a space in the game space immediately above the first region setting object A1, and/or a space in the game space immediately below the first region setting object A1 are included in a region (the first region R1). As an example, the first region R1 is formed by a cylindrical space that extends up to a limit height in the vertical direction, and the axis of which is a vertical straight line passing through the position of the first region setting object A1 in the game space.

The shape of the first region R1 may, as an example, be different from a cylindrical shape extending up to a limit height in a direction in a game space, and may be that illustrated in FIG. 16 as another example. As illustrated in FIG. 16, another example shape of the first region R1 is a hemispherical-cylindrical shape that is a combination of a cylinder the axis of which is a vertical straight line in a game space that passes through the position of the first region setting object A1, and a hemisphere the center of which is located at the position of the first region setting object A1 and the pole of which is located above the first region setting object A1.

In addition, in the game space, when the first region setting object A1 is moved, the first region R1 may also be moved due to the movement. Thus, by moving the first region setting object A1 to another position, the first region R1 can be set at a position different from the position that has been set once.

In another example, a user region that is set by a user in the game space (e.g., the first region R1) may be able to be set irrespective of region setting objects (without disposing a region setting object in the game space). As an example, when a user is given a predetermined range in the game space in return for a predetermined item (e.g., in-game currency or points given to a user in a game), the range may be set as a user region for the user. As another example, each user may be previously given a respective user region.

In the present example, a game space in the user region is set to a reclaimed state on a unit region by unit region basis. In the present example, the game field may be in one of an unreclaimed state and a reclaimed state on a unit region by unit region basis. In the initial state of a game, all unit regions in the game field may be in the unreclaimed state, and when a unit region is set to the reclaimed state, the display form of the game field may be changed in said unit region. As an example, in the reclamation region Ra, reclaimed unit regions may be caused to be brighter than unreclaimed unit regions so that the reclaimed unit regions can be distinguished from other regions.

In the present example, the game field is divided into a plurality of sections. A section includes a plurality of unit regions. In the present example, the game field is not divided into a plurality of sections in the vertical direction. In another example, the game field may be divided into a plurality of sections in the vertical direction. In addition, sections have equal sizes (the size is represented by the number of unit regions included in a section) (e.g., each section includes 512×512 unit regions). It should be noted that in the present example, a section serves as an example of a game session including a player group in which player characters operated by a plurality of user participate. Therefore, in the present example, game play using a plurality of game sessions can be performed by preparing a plurality of sections.

The reclamation situation of a section may be changed from a reclamation-uncompleted state to a reclamation-completed state, depending on the reclamation of a unit region by a player character. For example, when the number of unit regions in a section that have been reclaimed has reached a predetermined value, a reclamation condition may be satisfied, and the section may be set as a reclamation-completed state.

In addition, control may be performed as to whether to permit or forbid a player character to move between sections, based on at least one of the following determination items, depending on the reclamation situation of the sections.
Movement from one section to another section is allowed when the following two conditions are both satisfied. A first condition is that the section at the departure point and the section at the destination are both in an open state. As used herein, the open state means that at least one of adjacent sections is in the reclamation-completed state. A second condition is that one of the section at the departure point and the section at the destination is in the reclamation-completed state.
Movement to another section is allowed when the section at the departure point is in the reclamation-completed state.
Movement to one of a section group at the destination when the section at the destination is in the reclamation-completed state, and a section group in which a player character has stayed last is the section group at the destination. As used herein, the section group refers to a set of adjacent sections in the reclamation-completed state. In this determination item, a player character is allowed to move into the same section group in which the player character is staying, and can be prevented from moving to another section group through a section in the reclamation-uncompleted state adjacent to both of a plurality of different section groups.

It should be noted that even in the case in which a player character is allowed to move between the sections under the above determination item, the movement may be forbidden when movement of a player character between sections is forbidden under a capacity condition for each section described below. In addition, even in the case in which movement of a player character between sections is permitted under the capacity condition for each section described below, the movement may be forbidden when movement of a player character between sections is forbidden under the above determination item.

In the present example, a section information image can be displayed which indicates, for each section, a region setting object disposed on a game field, the position of a player character in the section, and the like. For example, in the present example, when the user performs an operation instruction input for displaying the section information image, a map image is displayed which allows current section information of each section to be seen. At least one piece of information used for displaying the section information image may be obtained from the server 102 when the information is displayed. Alternatively, at least one piece of information used for displaying the section information image that is regularly obtained by the main body apparatus 2 from the server 102 may be used.

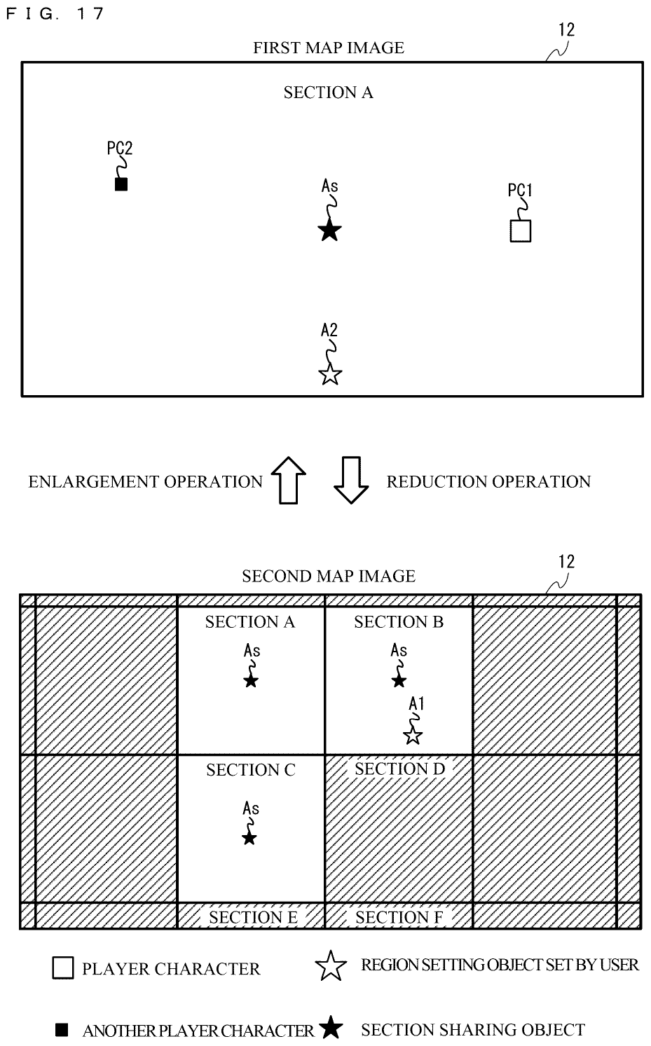

FIG. 17 shows an example of the section information image displayed on the display 12. In FIG. 17, the example of the section information image is displayed in the form of a map image of a game field included in a predetermined range as viewed downward from directly above in the game space. The section information image shows sections that are disposed in a horizontal grid pattern in the game field. In the example shown in the lower diagram of FIG. 17, sections A to F are displayed as a map image displayed on the display 12. Specifically, in the map images shown in the upper and lower diagrams of FIG. 17, the player character PC1 has entered the section A, and the region setting object A1 of the player character PC1 is disposed on the section B.

It should be noted that in the present example, a first map image showing first section information may be displayed for a section in which the user is participating as one of an operator and a viewer (in the example of FIG. 17, the section A; hereinafter denoted as a participation section). Here, the first section information is related to the participation section that is displayed by displaying an enlarged map image, and contains detailed information having a relatively large information amount. The first section information may, for example, include the current position of a player character operated by the user, the current positions of player characters operated by other users, the movement track (footmarks) of a player character operated by the user, information indicating the history of editing of an object disposed in the game space, the position of a region setting object, information indicating at most one section sharing object associated with each section (e.g., an object indicated by an icon As in FIG. 17), information indicating coordinates of a reclaimed unit region, and the like. In addition, more detailed information may be able to be checked by the user operating a cursor in the first map image. For example, when the user performs an operation of placing the cursor on an icon indicating a player character operated by another user (e.g., an icon PC2 in FIG. 17), the account name of the user operating the player character may be displayed.

In addition, in the present example, a second map image showing second section information may be displayed for a participation section in which the user is participating as one of an operator and a viewer and surrounding sections (in the example of FIG. 17, the sections B and C). Here, the second section information is related to the participation section and the surrounding sections displayed by displaying a reduced map image. Information about the section A displayed in the first map image may have a greater amount of information than that of information about the section A shown in the second map image, or may contain more detailed information such as the position of a player character than that of the information about the section A shown in the second map image. The second section information may, for example, include information indicating whether or not a section satisfies a reclamation completion condition, information indicating the reclamation situation of a section, information indicating social activity performed in a section, and information indicating at most one section sharing object associated with each section. It should be noted that the surrounding sections may be four sections adjacent to a participation section, eight sections surrounding a participation section, or sections in a wider range. In addition, the second section information may not be displayed for one or more of the surrounding sections that do not satisfy a predetermined condition, if any. For example, the second section information may not be displayed for a section that corresponds to at least one of a section in which the section sharing object is not disposed, a section in which no region setting object and no player character are disposed, and a section in which the reclamation value is less than a predetermined value. Furthermore, when the surrounding sections include a section in which the user has disposed a region setting object, information indicating that a region setting object is disposed (e.g., in the example of FIG. 17, a region setting object indicated by the icon A1 in the section B) may be included. In the present example, one of the first map image and the second map image is displayed based on the user's operation of enlarging or reducing a map image. It should be noted that in another example, both of the first map image and the second map image may be simultaneously displayed. For example, when the section information image including the participation section and the surrounding sections is displayed, the second map image may be displayed for the surrounding sections at the same time when the first map image is displayed for the participation section.

Thus, in the present example, the first map image shows more detailed information than that of the second map image. Therefore, when the user desires to obtain the first section information, the user needs to participate in a section in which the user desires to obtain the first section information, as an operator or viewer. It should be noted that in another example, the second map image may also show the first section information.

In addition, the frequency with which the second section information shown in the second map image is updated may be lower than the frequency with which the first section information displayed in the first map image is updated. In addition, when a zoom-out operation is performed on the first map image, the first map image may be changed to the second map image, and when a zoom-in operation is performed on the second map image, the second map image may be changed to the first map image. As another example, when a zoom-out operation is further performed on the second map image, a third map image having a smaller information amount for each section may be displayed.

In addition, the map image may be displayed in the form in which a game field included in a predetermined range is viewed downward from diagonally above in the game space. In addition, the horizontal direction in the section information image may be a direction along a spherical surface. For example, in the case in which an entire game field is configured in the form of a spherical celestial body, the horizontal direction in the section information image is along a spherical surface corresponding to the shape of the celestial body. In that case, the sections disposed in the grid pattern in the section information image are displayed and disposed in a grid pattern in a direction along the spherical surface.

In the present example, the user of the game system 1 is allowed to participate in each section as at least one of an operator and a viewer. The operator is allowed to participate in a section by causing a player character PC corresponding to the game account of the user (hereinafter simply referred to as an account or user account) to enter the section, and edit the game space by operating the player character PC, for example.

The operator is allowed to operate a player character PC corresponding to the operator, and edit a terrain and the like in the game space, and participates in a game as a participant for a section. Meanwhile, the viewer is allowed to participate in a section in which an object to be spectated is disposed, as the user's account, by at least spectating an in-game content (e.g., another player character PC or a region setting object A) in the game. The viewer participates in a game as a spectator of a read-only section that spectates an in-game content (e.g., the region setting object A of another player character PC) as an object to be spectated, and basically, does not transmit updated information of the game space to the server 102. The account participating as a viewer is not allowed to operate the player character PC and therefore is not allowed to edit or the like the game space. However, the account participating as a viewer is allowed to participate in the section as a spectator of the section that is allowed to control a virtual camera for viewing the object to be spectated and give social data (e.g., evaluation data such as “like”) to the object to be spectated. In addition, when the viewer spectates a region setting object A set in the game space as an object to be spectated, because a present or message sent by another user may be disposed in the vicinity of the region setting object A as described above, it is preferable to check such a present or message.

In the present example, the user participating in a section as an operator is allowed to switch from the section in which the user is participating as an operator to a section (switch destination section) if the capacity condition in the switch destination section is not exceeded. The user participating in a section as an operator is allowed to participate as a viewer in a section in which the user desires spectating if the capacity condition in the section in which the user desires spectating is not exceeded. In addition, the user participating in a section as a viewer is allowed to switch from the section in which the user is participating as a viewer to a switch destination section if the capacity condition in the switch destination section is not exceeded. The user participating in a section as a viewer is allowed to participate as an operator in a section in which the user desires to participate if the capacity condition in the section in which the user desires to participate as an operator is not exceeded.

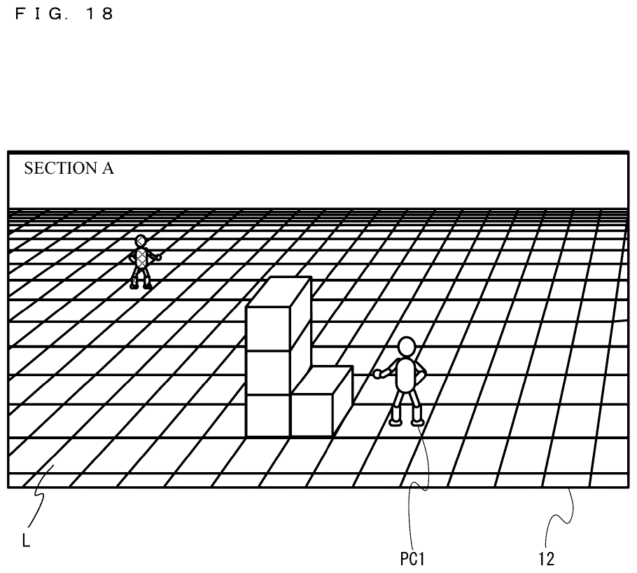

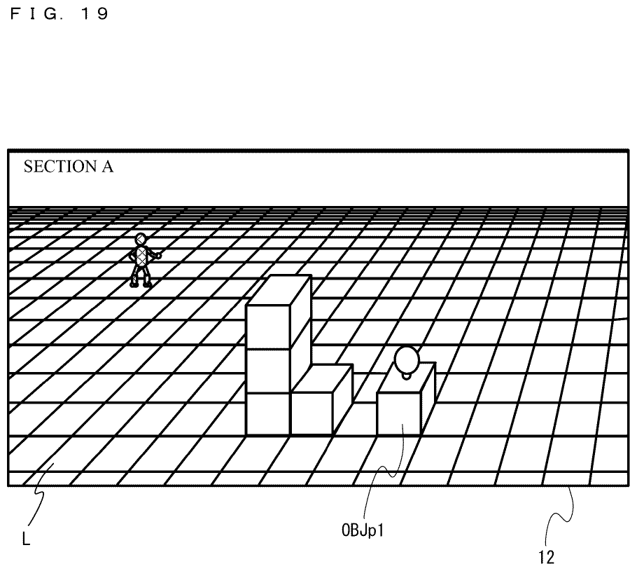

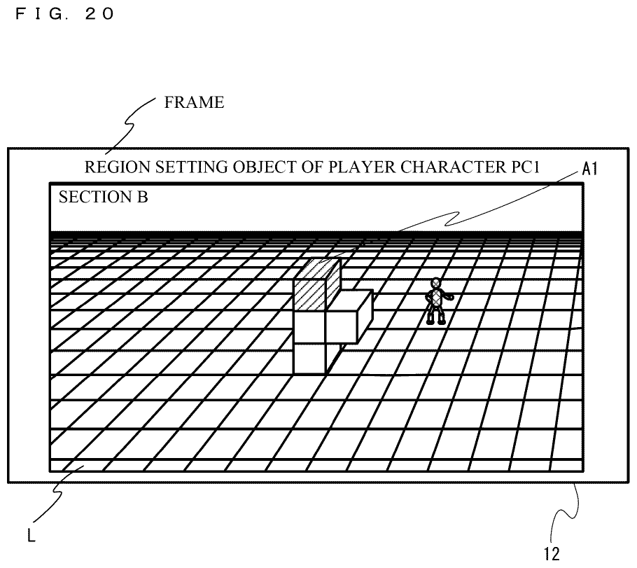

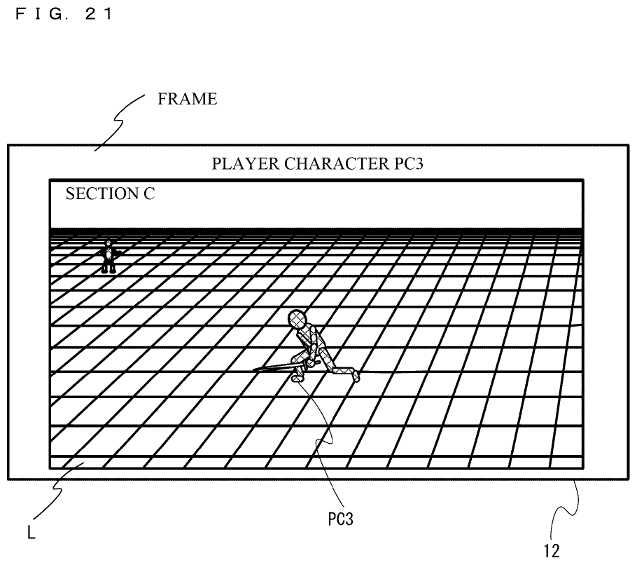

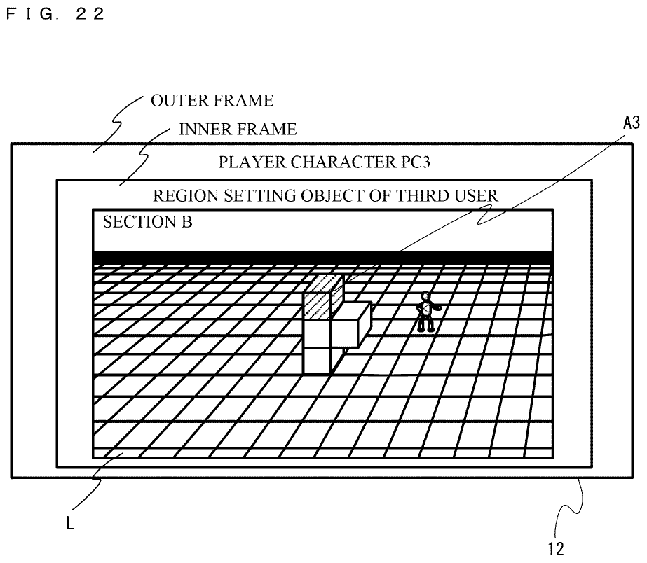

An example in which a user that is previously the operator participates as a viewer will be described with reference to FIGS. 18 to 22. It should be noted that FIG. 18 is a diagram showing an example of a game image showing that a player character PC1 has entered a section A. FIG. 19 is a diagram showing an example of a game image showing that a stay piece OBJp1 is disposed in the section A. FIG. 20 is a diagram showing an example of a game image showing that a first user is spectating, as a viewer, a region setting object A1 in a section B. FIG. 21 is a diagram showing an example of a game image showing that a first user is spectating, as a viewer, a player character PC3 in a section C. FIG. 22 is a diagram showing an example of a game image that is displayed when a user corresponding to an object to be spectated is a viewer of another object to be spectated.

In FIG. 18, the first user operating the player character PC1 has caused the player character PC1 to enter the section A, and is participating as an operator of the section A. In the present example, when a participation request transmitted from the game system 1 is accepted by the server 102, the first user is allowed to participate in the section of the request for participation as an operator. For example, the game system 1 operated by the first user transmits, to the server 102, a participation request for allowing the first user to participate in the section A as an operator. Thereafter, when the capacity condition of the section A is not exceeded by an increase in the number of operators due to the received participation request, the server 102 accepts the participation request. When the participation request is accepted, game information about a state of a game in the section A is transmitted from the server 102 to the game system 1 corresponding to the account of the first user participating in the section A, for which the participation request has been accepted. Thereafter, the game system 1 of the first user generates a game space of the section A including a player character PC1 based on the game information received from the server 102.

As shown in FIG. 18, a virtual camera for displaying a game image on the display 12 of the game system 1 of the first user is controlled based on the position of the player character PC1. In addition, updated information of the game space is transmitted to the server 102 based on a state of the game space in the section A updated based on an action or the like of the player character PC1. Thereafter, the server 102 updates game information of the section A managed by the server 102, based on the received updated information.

In the present example, the user participating in a game as an operator is allowed to make a request for participating as a viewer in the section in which the user is participating, or another section, by performing a predetermined operation.

As a first example, by performing an operation of selecting an object to be spectated form an image showing a player character PC or a region setting object A displayed in the above map image (see FIG. 17), a request for participation as a viewer for the object to be spectated can be performed. In the first example, only the player character PC disposed in the section in which the user is participating as an operator may be able to be selected as an object to be spectated. In addition, in the first example, only the above section sharing object and the region setting object A disposed in the game space by the operator may be able to be selected as an object to be spectated.

As a second example, by performing an operation of selecting an object to be spectated from a list of a user (player character) participating in a game, a request for participation as a viewer of the object to be spectated can be made. The list may be displayed in response to a predetermined operation, or by a predetermined scene being executed in a game. In addition, the list may include users (player characters) previously registered under a predetermined condition. As an example, the list may include a friend of the operator and other player characters PC that the player character PC operated by the operator has contacted in the game space in the past. The contact may be an action performed in the game space such as greeting and sending/receiving social data (e.g., “like”)).

As a third example, by a player character performing an action based on a predetermined operation input, on a predetermined in-game content (e.g., a region setting object) in the game space, a request for participation as a viewer in which a player character operated by the user associated with the in-game content or the in-game content is an object to be spectated can be made. It should be noted that the participation request may be made immediately after the action is performed as a trigger, or may be made by an operation of utilizing an item (e.g., a spectating card) obtained in response to the action after the item is obtained, as a trigger. It should be noted that the item may be stored as an inventory of the user that has obtained the item. In addition, as another example, when a player character gets on a terrain object in which data related to an object to be spectated is embedded, an in-game content based on the embedded data may be set as an object to be spectated.

In FIG. 19, a stay piece OBJp1 is disposed instead of the player character PC1 during the period of time when an operation different from the operation of the player character PC1 is being performed such as the period of time when the first user participating in a game as an operator is performing an operation of requesting participation as a viewer, or the period of time when the first user is participating as a viewer. The stay piece OBJp1 is a virtual object having appearance different from that of the player character PC1, and is disposed at a position based on the position at which the player character PC1 has been disposed last in the section in which the operator has participated. The stay piece OBJp1 indicates the position at which the player character PC1 will appear when returning to the section after the end of the above period of time. The returning is performed by the player character PC1 appearing in the game space instead of the stay piece OBJp1. Therefore, the disposition of the stay piece OBJp1 can report that one of the users participating in the section in which the stay piece OBJp1 is disposed is performing an operation different from that which is performed as an operator in the section.

It should be noted that the stay piece OBJp1 is set such that the stay piece OBJp1 cannot be edited in the game space. For example, a limitation may be imposed on editing that is destruction or movement of the stay piece OBJp1 itself, and in addition, editing of other objects around the stay piece OBJp1. Specifically, a limitation may be imposed on editing that is placement of another object on the stay piece OBJp1, editing that is deletion of another object directly below the stay piece OBJp1, and the like. As a result, the player character PC1 operated by the first user can be prevented from, when the first user operating the player character PC1 participates in a section before spectating, again as an operator, failing to return to the section, being unable to move after returning to the section, and the like, due to disposition of another object at the position of the stay piece OBJp1 or therearound during the spectating. It should be noted that no limitation may be imposed on movement of a stay piece placed by another user. In addition, the stay piece OBJp1 may be removed from the game space after a predetermined period of time (e.g., an hour) has passed with the stay piece OBJp1 remaining unchanged since the disposition of the stay piece OBJp1 in the game space.

As shown in FIG. 20, when participation in the section B as a viewer for which the region setting object A1 disposed in the section B is an object to be spectated is permitted, a frame that reports the object to be spectated is displayed on the display 12 of the game system 1 of the first user is displayed, and a game image in which the section B is spectated is displayed in the frame. In the present example, when the first user's participation request for participation in the section B as a viewer is accepted, game information about a state of a game in the section B is transmitted from the server 102 to the game system 1 corresponding to the account of the first user participating to the section B, for which the participation request has been accepted. Thereafter, the game system 1 of the first user generates, based on the game information received from the server 102, a game space of the section B including an in-game content that is an object to be spectated (here, the region setting object A1 disposed in the game space by the player character PC1).

As shown in FIG. 20, a virtual camera for displaying a game image on the display 12 of the game system 1 of the first user is controlled based on the position of an object to be spectated (the region setting object A1). For example, the virtual camera may be controlled so as to be able to rotate about an object to be spectated with the gaze point positioned at the object to be spectated, based on an operation performed by the first user participating in the section B as a viewer. Thus, when the user participates in a game as a viewer that spectates a region setting object disposed in a section, a game image that causes the user themselves to feel as if the user were present in the section can be displayed.

As shown in FIG. 21, when the first user is permitted to participate in the section C as a viewer with a player character PC3 entering the section C set as an object to be spectated, a frame reporting the object to be spectated is displayed on the display 12 of the game system 1 of the first user, and a game image in which the section C is spectated is displayed in the frame. In the present example, when the first user's participation request for participation in the section C as a viewer is accepted, game information about a state of a game in the section C is transmitted from the server 102 to the game system 1 corresponding to the account of the first user participating in the section C, for which the participation request has been accepted. Thereafter, the game system 1 of the first user generates a game space of the section C including an in-game content (here, the player character PC3) that is an object to be spectated, based on the game information received from the server 102.

As shown in FIG. 21, a virtual camera for displaying a game image on the display 12 of the game system 1 of the first user is controlled based on the position of an object to be spectated (the player character PC3). For example, when the player character PC3, which is an object to be spectated, moves in the game space, the virtual camera is also moved, following the movement of the player character PC3. In addition, the virtual camera may also be controlled so as to rotate about the object to be spectated with the gaze point positioned at the object to be spectated, based on an operation performed by the first user participating in the section C as a viewer. Thus, when the user participates in a game as a viewer spectating another player character that has entered a section, a game image that causes the user themselves to feel as if the user were present in the section can be displayed.

It should be noted that when the user participates in a game as a viewer of a section, a non-displayed player character PC that corresponds to the viewer may be disposed in the section, and may be disposed, overlaying an object to be spectated. In that case, the virtual camera for displaying a game image of a section is controlled based on the position of the non-displayed player character PC. For example, based on the movement of an object to be spectated or the viewer's operation of moving a non-displayed player character PC in the game space, the virtual camera is also moved, following the movement. In addition, the virtual camera may be controlled so as to rotate about the non-displayed player character PC with the gaze point positioned at the non-displayed player character PC, based on the viewer's operation. In that case, the user's play video related to an object to be spectated is not received, and the viewer's account directly moves to a section and disposes a virtual camera to obtain a game image. Therefore, a predetermined interaction (e.g., giving social data) can be performed for the object to be spectated. In addition, by borrowing the right to operate an object to be spectated, the viewer may be allowed to operate the object to be spectated instead of the operator for the object to be spectated. In another example, if the user participates in a game as a viewer of a section, then when the user's play video related to an object to be spectated is received through the server 102, a game image showing that the play video is spectated by the viewer may be displayed.

In addition, an in-game object that can be selected as an object to be spectated may be any object that is disposed in the game space. For example, an in-game object that can be selected as an object to be spectated may be the above region setting object or another player character, and in addition, a section sharing object disposed in each section. The section sharing object may be disposed when a section is generated, when an adjacent section is in the reclamation-completed state (e.g., a section is in the open state), or when the user participates in a section for the first time. As another example, the section sharing object may be disposed previously (e.g., when a virtual space is generated). The section sharing object may be able to be selected as an object to be spectated by all users, and may be able to be selected from the above second map image or a selectable object list even when the section sharing object is disposed in a section in which the first section information has not been released.

In addition, when the user participates in a game as a viewer of another section (e.g., in the second map image of FIG. 17, the section sharing object As is selected as an object to be spectated, so that the user participates as a viewer of a section in which the section sharing object As is disposed), information about a region setting object A, a player character PC, or the like in the section (e.g., information about the position, type, number, reclamation value, and the like) is released to the viewer of the section by obtaining the information from a server that manages first section information in the section with respect to the user.

In addition, when a player character PC (first object to be spectated) is an object to be spectated of the user, then if another user (second user) corresponding to the player character PC is spectating, as a viewer, another object to be spectated (second object to be spectated), a game image may be displayed in which the second object to be spectated, which is being spectated by the second user, is an object to be spectated.

For example, it is assumed that a third user corresponding to the player character PC3 is participating in the section B as a viewer for which a region setting object A3 disposed in the section B3 is an object to be spectated. In that case, when the first user transmits a participation request for participation as a viewer for which the player character PC3 is set as an object to be spectated, the server 102 determines whether or not the first user is allowed to participate as a viewer for which the region setting object A3 disposed in the section B is set as an object to be spectated. When the participation request is accepted, a game image in which the region setting object A3 disposed in the section B, which is being spectated by the third user, is set as an object to be spectated is displayed on the display 12 of the game system 1 of the first user.

In this case, as shown in FIG. 22, an outer frame reporting the first object to be spectated (player character PC3) for which the first user has made a participation request is displayed on the display 12 of the game system 1 of the first user. An inner frame reporting user information (account name) associated with the second object to be spectated (region setting object A3) that is being spectated by the third user corresponding to the first object to be spectated, and the region setting object A3, is displayed inside the outer frame. A game image in which the section B, in which the second object to be spectated is disposed, is spectated is displayed in the inner frame.

As shown in FIG. 22, a virtual camera for displaying a game image in which the object to be spectated has transitioned is controlled based on the position of the second object to be spectated (e.g., the region setting object A3). For example, when the second object to be spectated is moved in the game space, the virtual camera is also moved, following the movement. In addition, the virtual camera may also be controlled so as to rotate about the second object to be spectated, based on the first user's operation, with the gaze point positioned at the second object to be spectated. By thus displaying a game image in which an object to be spectated has transitioned, the user is allowed to know another user's play situation that the user desires to set as an object to be spectated.

In addition, when a player character PC is an object to be spectated of the user, then if another user (second user) corresponding to the player character PC is spectating, as a viewer, another object to be spectated, the second user may participate as a viewer of a section in which a stay piece (see FIG. 19) is disposed in the game space instead of the player character PC, with the stay piece set as an object to be spectated.

In addition, when a player character PC is an object to be spectated of the user, then if another user (second user) corresponding to the player character PC switches from the viewer to an operator for the player character PC, a game screen on which an object to be spectated for the viewer is spectated may be replaced by a game screen on which the player character PC is an object to be spectated. In that case, the server 102 determines whether or not participation as a viewer in the section in which the player character PC corresponding to the second user is disposed is allowed. When the result of the determination is positive, a game image in which the object to be spectated has been replaced may be displayed.

In addition, as an example, a limitation may be imposed on the number of times the object to be spectated is caused to transition. By thus limiting the number of times an object to be spectated is caused to transition, the phenomenon that an object to be spectated for which a request for participation as a viewer has been made transitions back to a player character PC corresponding to a user that has made the participation request can be prevented. As another example, in the case of the above phenomenon, a request for participation as a viewer may not be accepted.

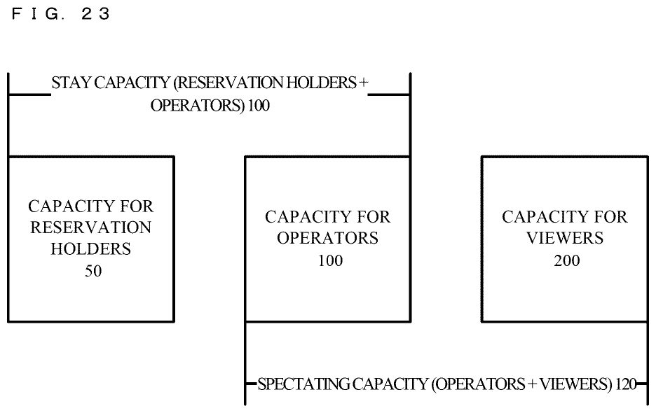

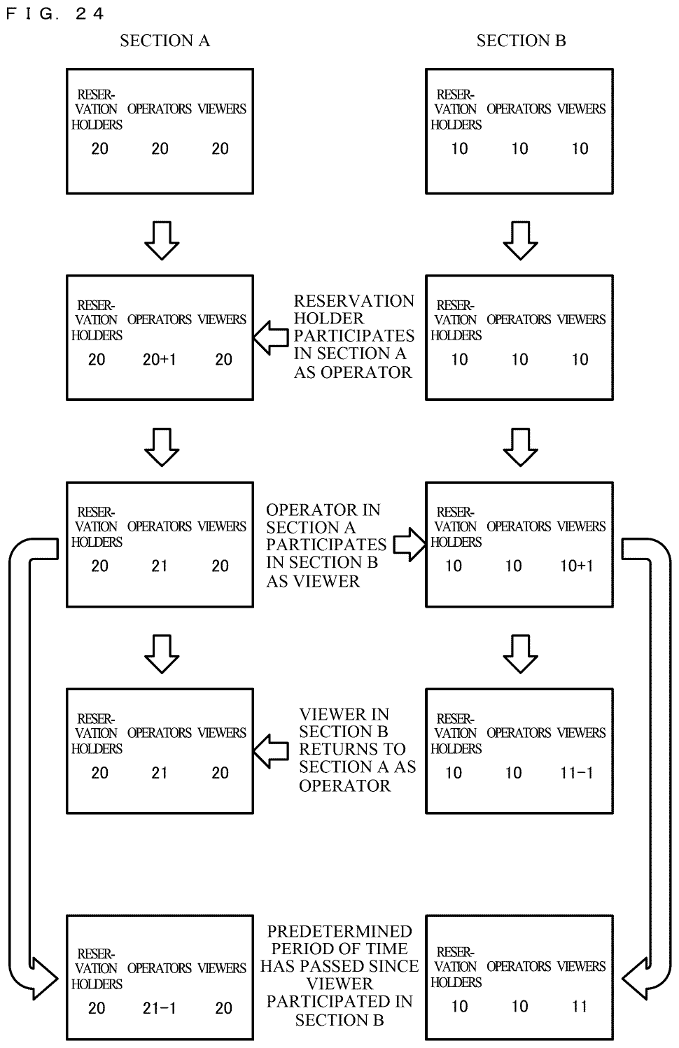

Next, an example of a condition for the maximum number of users that are allowed to participate in a section (capacity condition) and an example of the transition of the number of participants in a section will be described with reference to FIGS. 23 and 24. It should be noted that FIG. 23 is a diagram showing an example of the capacity condition of each section. FIG. 24 is a diagram showing an example of the transition of the number of participants in each of sections A and B.

As shown in FIG. 23, in the present example, a capacity for each of reservation holders, operators, and viewers, a stay capacity for stayers that are one of a reservation holder and an operator, and a spectating capacity for both operators and viewers are set for each section. As used herein, the operator refers to a user (section participant) that is participating in a section, operating a player character that the operator has caused to enter the section. The viewer refers to a user (section spectator) that is participating in a section, spectating an object to be spectated in the section. The reservation holder refers to a user for which a user region (e.g., the first region R1 of FIGS. 15 and 16) has been set in a section.

The stay capacity is set based on the capability of the server 102 managing a section to process the section (e.g., processing cost or communication cost). In the example of FIG. 23, the stay capacity is set to 100. For example, the stay capacity is set based on the upper limit of the number of participating terminal apparatuses (game systems 1) for which at least a process of constructing a most recent game space or the like can be executed between the server 102 and the terminal apparatuses by editing a game space in a section and transmitting and receiving game information about the editing to and from the server 102. Here, if a user region has been set in a section, then even when the reservation holder is not actually participating in the section as an operator, a reservation holder is counted. Thus, for the stay capacity, the number of reservation holders is previously set, and while operators the number of which corresponds to the previously set number are not allowed to participate in a section, the reservation holders are continuously allowed to participate in the section as an operator.

The spectating capacity is also set based on the capability of the server 102 managing a section to process the section. In the example of FIG. 23, the spectating capacity is set to 120. Here, for the viewer, the main process is to spectate an object to be spectated in a section. Therefore, compared to the operator, the processing cost and communication cost for the viewer are low, and therefore, if viewers are participating, the capacity can be increased proportionately, so that the spectating capacity can be greater than the stay capacity. It should be noted that the spectating capacity may be increased or decreased, depending on the number of users participating in a section for each role. For example, by reducing the number of operators participating in a section, the spectating capacity may be increased. As an example, when the number of users participating in a section as an operator is 50, the spectating capacity is set to 100. When the number of users participating in a section as an operator is 20, the spectating capacity is set to 120. Thus, the spectating capacity may be variably set.

As with the stay capacity, the capacity for operators is set based on the capability of the server 102 managing a section to process the section. In the example of FIG. 23, the operator capacity is set to 100.

The capacity for reservation holders is set to a value smaller than the above values based on the capability of processing a section (e.g., the stay capacity and the operator capacity). In the example of FIG. 23, the capacity for reservation holders is set to 50. Here, in the case in which the capacity for reservation holders is set based on the capability of processing a section, the section is permitted to be only filled with reservation holders. In that case, operators other than reservation holders are not allowed to newly participate in the section. Therefore, the capacity for reservation holders may be set based on the proportion of reservation holders occupying in a section that is considered to be appropriate.

The capacity for viewers is set based on the upper limit of the number of participating terminal apparatuses for which at least a process of allowing a user to spectate an object to be spectated in a section, and the like, can be executed. In the example of FIG. 23, the capacity for viewers is set to 200. As described above, compared to operators, a processing cost and a communication cost for viewers are low, and therefore, the capacity for viewers can be set to a value greater than that of the capacity for operators and the capacity for reservation holders.

For each section, capacity control may be performed based on the following rules.
A. no new operator is allowed to participate in a section filled to the stay capacity
B. no new viewer is allowed to participate in a section filled to the spectating capacity, except for viewers that are also a reservation holder (e.g., a viewer for which a region setting object has been disposed in the section)
C. in a section filled to the spectating capacity, new operators are allowed to participate if the rule A is satisfied, and viewers that have been participating are forced to exit
D. in a section filled to the spectating capacity, new viewers that are also a reservation holder are allowed to participate, and viewers that have been participating are forced to exit
E. when an operator participates in the same section as a viewer, the operator is handled as an operator participating in the section

The above rules can be expected to lead to the following effects.
According to the rule A, a reservation holder for a section is invariably guaranteed to participate as an operator, and an operator that has been participating is not forced to exit the section due to a new operator.
According to the rules B and D, even when the number of viewers in a section increases, an operator that has been participating is not forced to exit the section.
According to the rule C, operators are allowed to participate in a section with higher priority.
According to the rules B and D, reservation holders for a section are allowed to participate in the section as a viewer with higher priority.
According to the rule E, in a section in which a user is participating as an operator, the user can freely switch the role between an operator and a viewer and participate in the switched role.
According to the rule E, even when an operator switches to a viewer in a section in which the operator has been participating, other viewers in the section are not forced to exit.

The forced exit from a section may be performed based on the following rules.
F. a viewer that is forced to exit is determined based on the time that has elapsed since the start of viewing, and is a viewer that has participated most recently or earliest (a viewer that is forced to exit may be selected based on the time at which the viewer participated or the order in which viewers participated)
G. a viewer that is also a reservation holder in a section is not forced to exit
H. a viewer that has been forced to exit returns, as an operator, to a section in which the viewer stayed before being the viewer
I. when there is no section to which a viewer returns according to the rule G, a viewer moves to a predetermined game space different from sections

For example, the “predetermined game space” refers to a particular management area (instance room) that does not belong to any section. In the management area, a player character is disposed during the start of a game or the like. In addition, the management area is a game space in which editing by a user's operation is not allowed. A plurality of management areas having the same function are prepared. For example, when the participation capacity of one management area is reached, a new management area may be generated, so that the participation capacity of the management area may be increased. As an example, in the management area, a player character may purchase an item, get an increase in level depending on a game score, receive supply of items, parameters, or the like, select a section in which the player character desires to participate, be assigned to a section in which the player character is to participate, and the like. As another example, the management area may be a game space in which no limitation is imposed on participation of an operator (player character) (the capacity is not limited).

It should be noted that in another example, according to the rule F, a viewer spectating an object to be spectated different from that for which a participation request has been made (e.g., an example of the viewer described with reference to FIG. 22) may be forced to exit.

In the present example, a user participating in each section is managed in the server 102 using a participation list for each role. For example, the server 102 sets a reservation holder list, an operator list, and a viewer list for each section, and participants may be managed by describing the accounts of participating users in each participation list. The accounts of users in each participation list may be described based on a predetermined rule. For example, in each participation list, there may be duplicate user accounts, and when a predetermined condition is satisfied, some account(s) may be deleted to remove the duplication.

FIG. 24 shows an example of transition of participants described in a participation list for each of sections A and B. For example, in the uppermost diagram of FIG. 24, 20 accounts as a reservation holder, 20 accounts as an operator, and 20 accounts as a viewer are described in a section A. In addition, 10 accounts as a reservation holder, 10 accounts as an operator, and 10 accounts as a viewer are described in a section B.

In such a participant situation in the sections A and B, a user that is also a reservation holder in the section A is allowed to participate in the section A as an operator. In this case, in the second diagram from the top of FIG. 24, the number of operators in the section A is increased by one, so that there are 21 accounts as an operator in the section A. It should be noted that even when a reservation holder participates in the section A as an operator, the number of stayers in the section A is only increased by one. Specifically, the number of stayers is derived as follows.

The number of current reservation holders+the number of current operators−the number of reservation holders staying as an operator=the number of stayers

As a result, the number of operators that are allowed to participate can be prevented from decreasing due to participation of a reservation holder as an operator. Thus, when a reservation holder participates in a section as an operator, the count of operators is increased, but the number of stayers does not increase. Therefore, when the stay capacity of the section A is not exceeded and the spectating capacity of the section A is exceeded, some existing viewer(s) is forced to exit the section A. It should be noted that the participation list of the section B is not changed due to the participation of an operator.

It should be noted that in another example, when a reservation holder participates in a section as an operator, the number of operators in the section is increased by one, and the number of reservation holders in the section may be decreased by one. For example, in the example of the section A, the number of operators in the section A may be increased by one, so that there are 21 accounts as an operator in the section A; and the number of reservation holders in the section A may be decreased by one, so that there are 19 accounts as a reservation holder in the section A.

Next, the user that has been participating in the section A as an operator is permitted to participate in the section B as a viewer. In this case, in the third diagram from the top of FIG. 24, the number of viewers in the section B is increased by one, so that there are 11 accounts as a viewer in the section B. Meanwhile, the number of operators in the section A, in which the user has been participating as an operator, remains as it is described in the account in order to allocate a capacity for accepting the user if the user will return to the section A as an operator. In addition, in the section A, the stay piece OBJp1 (see FIG. 19) is disposed instead of the player character PC1 that has been operated by the operator. It should be noted that if due to this process, the spectating capacity of the section B is exceeded and the newly participating viewer is a reservation holder in the section B, an existing viewer is forced to exit the section B. In addition, if the spectating capacity of the section B is exceeded and the newly participating viewer is not a reservation holder in the section B, participation in the section B as a viewer is not permitted, and playing as an operator in the section A is continued.

Next, the user that has been participating in the section B as a viewer is permitted to return to the section A as an operator. In this case, in the fourth diagram from the top of FIG. 24, the number of viewers in the section B is decreased by one, so that there are 10 accounts as a viewer in the section B. In addition, the number of operators in the section A, to which the user returns as an operator, is maintained as it is described in the list because a capacity for allowing the user to return to the section A is allocated, and therefore, the user is allowed to return to the section A. Thereafter, the player character PC1 that has been operated by the user is disposed instead of the stay piece OBJp1 disposed in the section A.

Meanwhile, as shown in the bottom diagram of FIG. 24, when a predetermined period of time (e.g., an hour) has passed since the user participated in the section B as a viewer, the allocated capacity for allowing the user to return to the section A as an operator is eliminated. In addition, the stay piece OBJp1 disposed in the section A is deleted from the section A. As a result, the number of operators in the section A is decreased by one, so that there are 20 accounts as an operator in the section A. It should be noted that an operator that is also a reservation holder is caused to exit the section A. However, a capacity for allowing the reservation holder to participate in the section A again is allocated because there are still 20 accounts as a reservation holder in the section A. In addition, the participation list of the section B is not changed due to the passage of the predetermined period of time. It should be noted that after this process, if the user that has been participating in the section B as a viewer requests returning to the section A as an operator, a capacity for accepting the user as a reservation holder is allocated in the section A, so that the stay capacity of the section A is not exceeded, and the user is allowed to return to the section A as an operator. Meanwhile, after this process, if, when the user that has been participating in the section B as a viewer requests returning to the section A as an operator, the stay capacity of the section A is exceeded and the user is not a reservation holder in the section A, the player character PC1 corresponding to the user is moved to a predetermined game space (e.g., a management area) and play is continued. In addition, as another example, when the predetermined period of time has passed since a viewer participated in the section B, the viewer may be caused to exit the section B and forced to return to the section A as an operator.

It should be noted that in the above capacity management, an example has been described in which when the user participates as a viewer, a capacity for allowing the user to return to a section as an operator is allocated for a predetermined period of time. In another embodiment, such a capacity may be allocated in association with section participation. For example, when an operator of a first section moves to a section as an operator of a second section or as an operator of the management area, a capacity for allowing the user to return to the first section as an operator may be allocated for a predetermined period of time. As a result, when the user tries to return to an original section after temporarily staying another section or the management area, the user can be prevented from failing to return to the original section due to the full capacity.

In addition, the process of allocating a capacity for a predetermined period of time indicates that the capacity is eliminated after the predetermined period of time has passed. By this process, an allocated capacity for operators in the section in which the user has originally stayed can be prevented from remaining after a viewer logs out (ends a game) while spectating a section or an operator logs out while having moved to another section. This process is effective when it is difficult to use server resources for managing different sections in association with each other. As another example, when it is easy to exchange information indicating the logging out between server resources for managing different sections, the process of eliminating an allocated capacity due to the passage of a predetermined period of time may not be executed.

In addition, in the present example, a section in which a viewer returns to an operator may be different from a section in which the user had been participating before being a viewer. For example, the user may select either a section in which the user is to return as an operator or a section in which the user is registered as a reservation holder. In the former case, a viewer for which the region setting object A1 is an object to be spectated may be able to perform an operation of designating the region setting object A1 as a position where the player character PC1 is to appear in the game space in order to participate as an operator. According to such an operation, the designated position is set as a stay position, and a request for participation as an operator in which the section including the stay position is set as a stay section is made, and when the participation request is accepted, the player character PC1 may be able to appear in the vicinity of the region setting object A1 and participate in the section as an operator. In that case, a predetermined consideration (e.g., in-game currency) may be required in order to allow the player character PC1 to appear in the vicinity of the above object to be spectated. In addition, in the latter case, the section that is a return destination may be selected in the game system 1 operated by the user, or in the server 102. In the present example, when a region setting object associated with the user themselves is an object to be spectated, the user is allowed to participate, as an operator, in a section in which a region setting object has been disposed according to a predetermined operation. As another example, when a region setting object associated with another user is an object to be spectated, the user may be caused to participate, as an operator, in a section in which a region setting object has been disposed according to a predetermined operation.

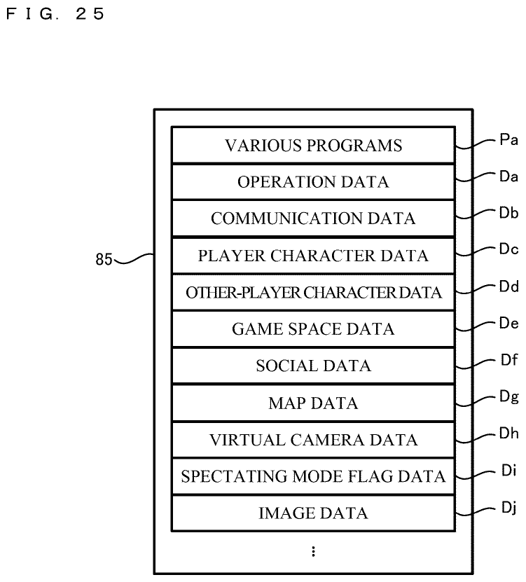

Next, an example of a specific process executed in the game system 1 will be described with reference to FIG. 25. It should be noted that data used in other processes is also stored in the DRAM 85 in addition to the data shown in FIG. 25, and will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, a communication program for communicating with other apparatuses (the server 102 and other game systems 1), and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, communication data Db, player character data Dc, other-player character data Dd, game space data De, social data Df, map data Dg, virtual camera data Dh, spectating mode data Di, image data Dj, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The communication data Db includes transmission data to be transmitted to other apparatuses (the server 102 and other game systems 1) and reception data received from other apparatuses. For example, the transmission data includes information about the action, state, and the like of a player character PC operated by the user of the game system 1, information about a game space changed by the player character PC's action, and the like. In addition, the reception data includes information about the actions, states, and the like of other player characters PC operated by the users of other game systems 1, information about a game space changed by the other player characters PC, and the like.

The player character data Dc indicates parameters such as the position, direction, pose, action, state, ability, remaining energy, and the like in a game space of a player character operated by the user of the game system 1 (hereinafter referred to as a first player character PC1), and the like. The other-player character data Dd indicates parameters such as the positions, directions, poses, actions, states, abilities, remaining energies, and the like in a game space of other player characters operated by the users of other game systems 1 (hereinafter referred to as a second player character PC2), and the like.

The game space data De indicates the state of a game space. For example, the game space data De indicates a parameter related to the state of a terrain object, and a parameter related to the state of an decorative object for each coordinate point set in a game space, i.e., a parameter indicating whether or not an object (a terrain object, region setting object, decorative object, stay piece, other objects, or the like) exists at each of a plurality of coordinate points, and parameters indicating the type, state (including an editor, embedded information, or texture), and the like of an existing object.

The social data Df is related to social points given to a player character (the first player character PC1) operated by a user of the game system 1 (can also be said to be social points given to a user of the game system 1), and social points given to other player characters.

The map data Dg indicates disposition information about a player character, region setting object, section sharing object, and the like, and information about the reclamation value, which are used in order to display the section information image, for each section.

The virtual camera data Dh indicates the position, direction, angle of view, and the like of a virtual camera disposed in a game space.

The spectating mode flag data Di indicates a spectating mode flag that is on when a game is being played in the spectating mode.

The image data Dj is for displaying images (e.g., an image of each player character PC, an image of each object, a map image, and a background image) on a display screen (e.g., the display 12 of the main body apparatus 2).

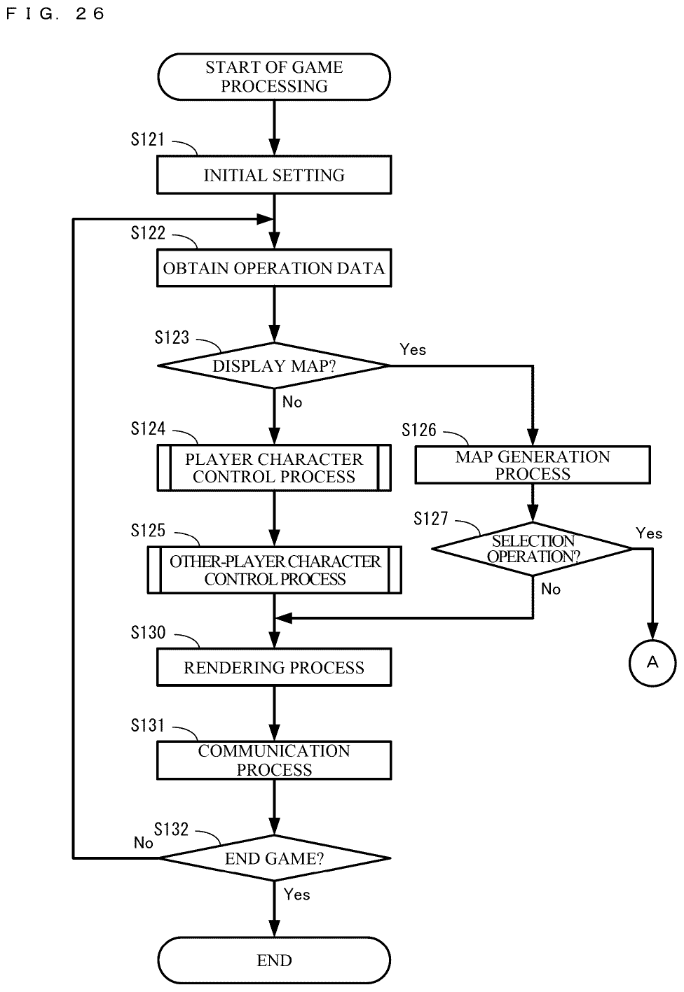

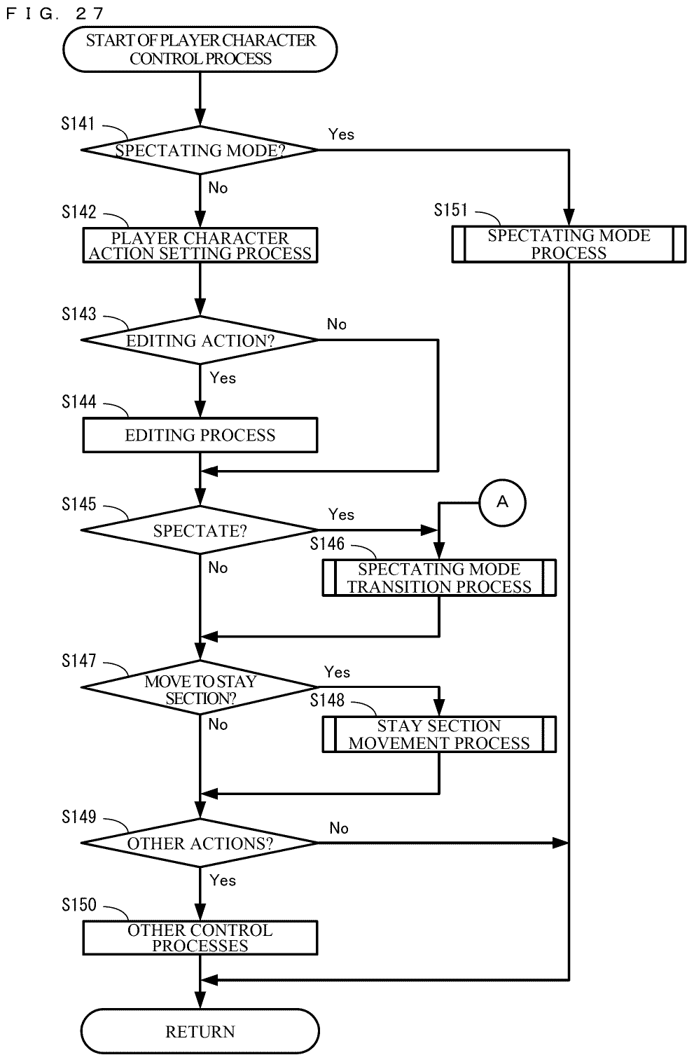

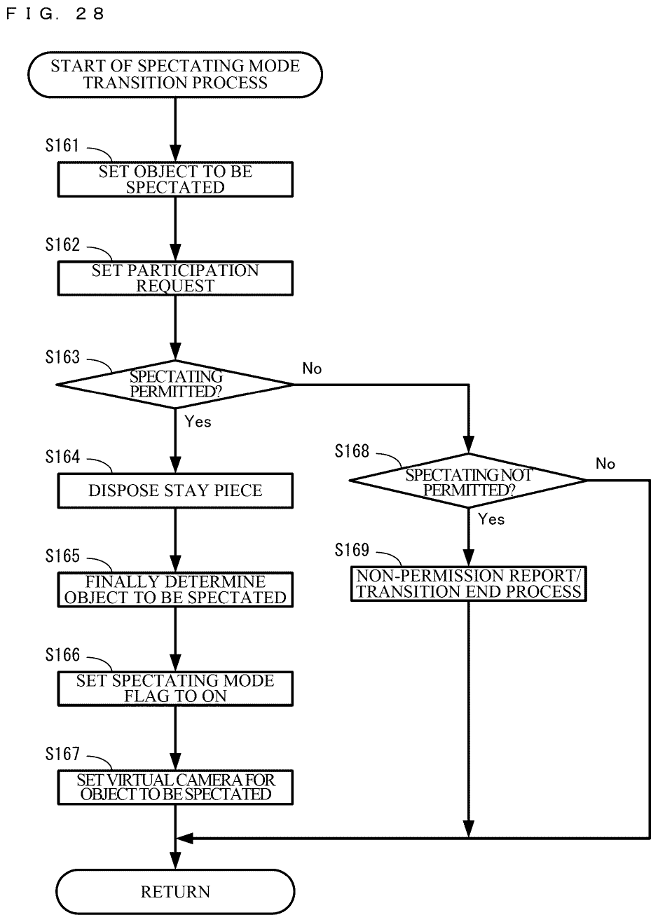

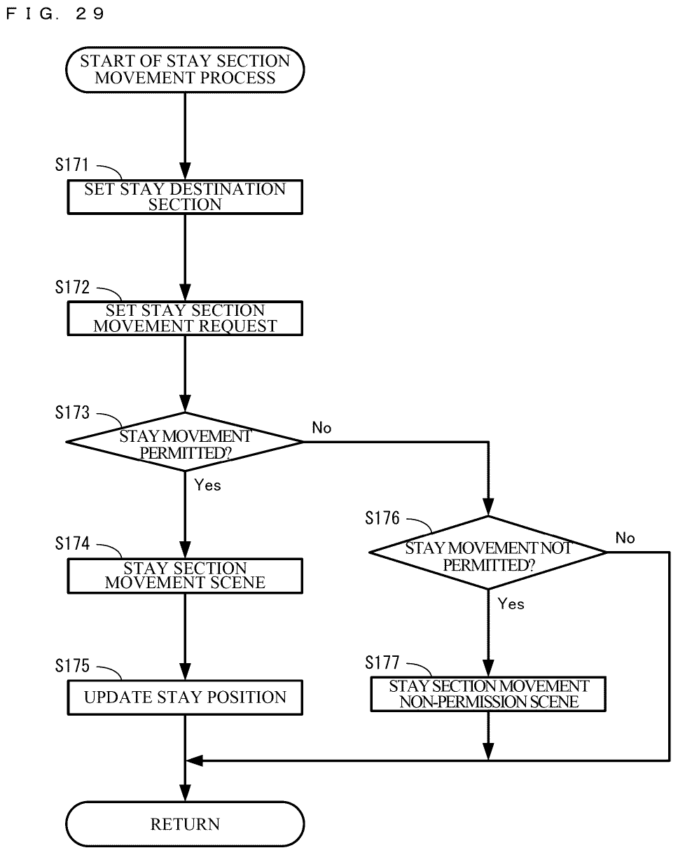

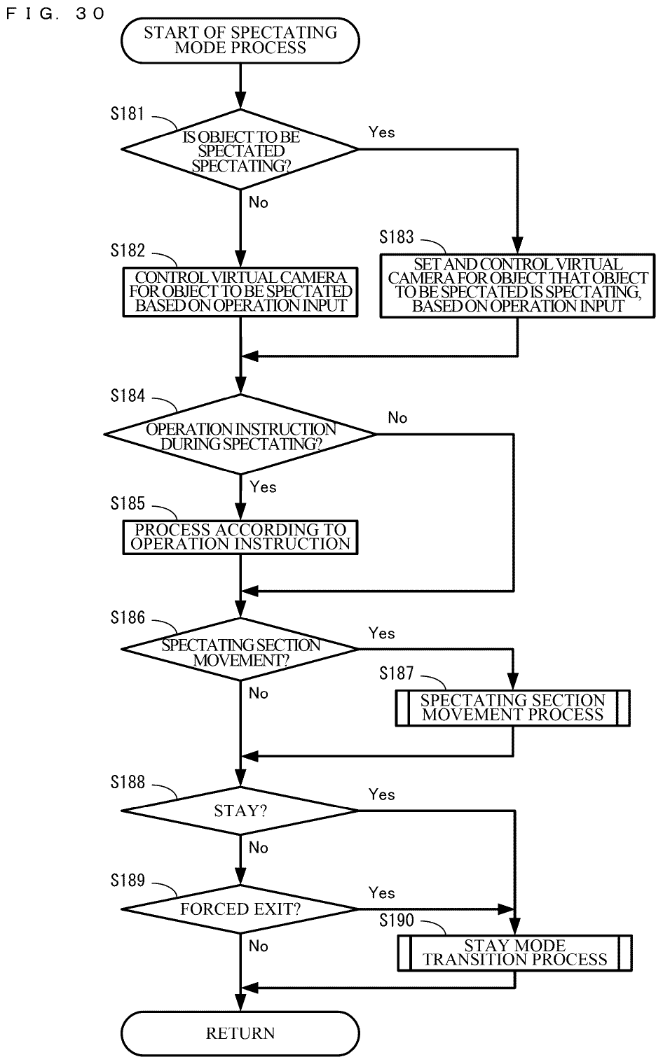

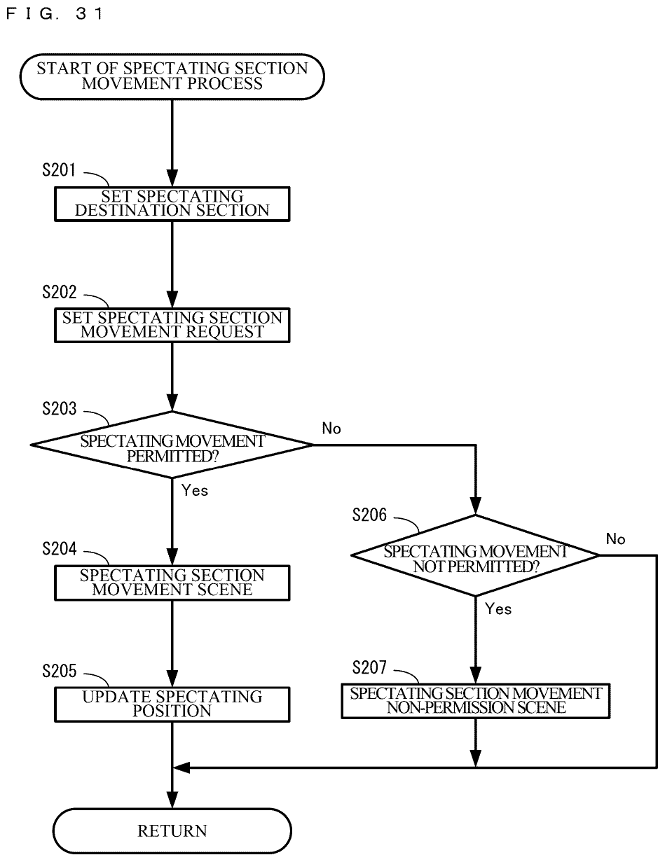

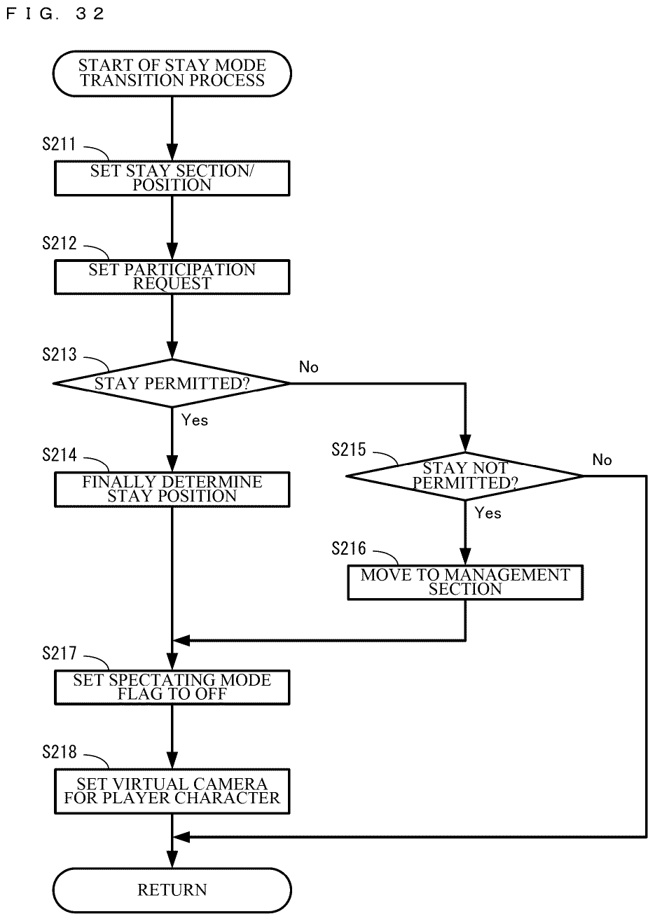

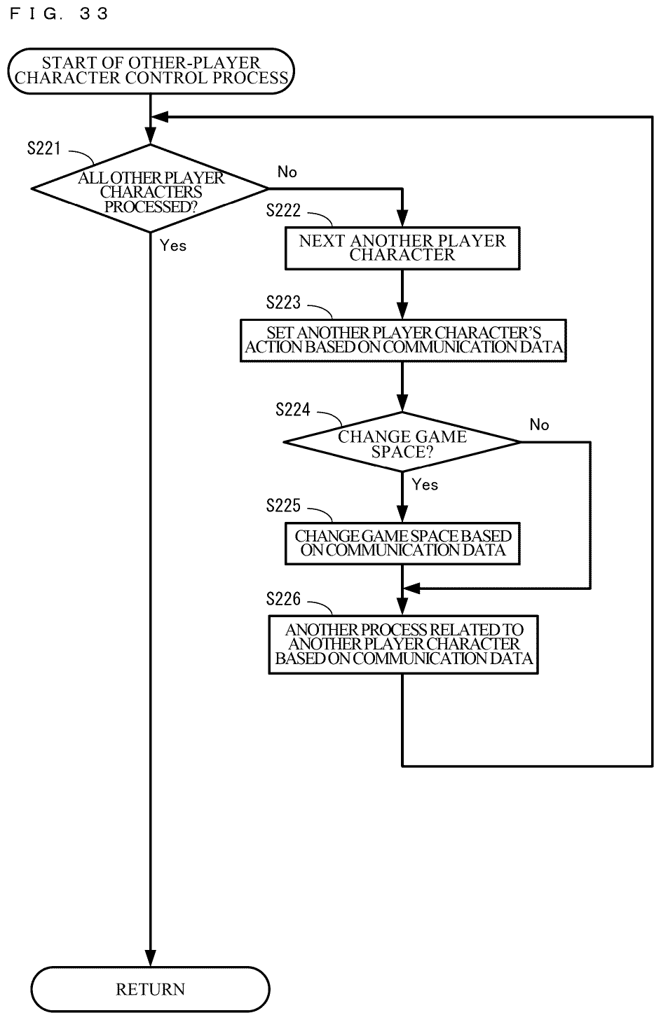

Next, a detailed example of game processing that is an example of information processing in the present example will be described with reference to FIGS. 26 to 32. It should be noted that FIG. 26 is a flowchart showing an example of game processing executed in the game system 1. FIG. 27 is a subroutine showing an example of a player character control process in step S124 of FIG. 26. FIG. 28 is a subroutine showing an example of a spectating mode transition process in step S146 of FIG. 27. FIG. 29 is a subroutine showing an example of a stay section movement process in step S148 of FIG. 27. FIG. 30 is a subroutine showing an example of a spectating mode process in step S151 of FIG. 27. FIG. 31 is a subroutine showing an example of a spectating section movement process in step S187 of FIG. 30. FIG. 32 is a subroutine showing an example of a stay mode transition process in step S190 of FIG. 30. FIG. 33 is a subroutine showing an example of an other-player character control process in step S124 of FIG. 26. In the present example, a series of steps illustrated in FIGS. 26 to 33 is executed by the processor 81 executing a predetermined application program (game program), a communication program, and the like included the programs Pa. The game process of FIGS. 26 to 33 is started with any appropriate timing.

It should be noted that the steps in the flowcharts of FIGS. 26 to 33, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., the server 102 and other game systems 1 that can communicate with the main body apparatus 2 via a network). Specifically, the steps of FIGS. 26 to 33 may be executed by a plurality of information processing apparatuses including the main body apparatus 2 cooperating with each other.

In FIG. 26, the processor 81 executes initial setting for the game process (step S121), and proceeds to the next step. For example, in the initial setting, the processor 81 initializes parameters for executing processes described below, and updates each data. As an example, in the case in which it is necessary to log in on the server 102 in order to start a game in which a plurality of users participate, the processor 81 performs a log-in process on the server 102 according to a log-in operation indicated by the operation data Da. In addition, the processor 81 transmits, to the server 102, a participation request for assignment of a section in which the user is to participate as an operator (e.g., assignment of a section in which the user has been set as a reservation holder), based on a user operation instruction input, obtains data related to a game space in the assigned section, and constructs the game space based on the data. Thereafter, the processor 81 disposes a first player character PC1 having a predetermined pose at a default position in the game space in the section, disposes a virtual camera or the like at a position based on the position where the first player character PC1 is disposed, and updates the player character data Dc, the game space data De, and the virtual camera data Dh. In addition, in a situation of a region setting object associated with the first player character PC1 in the game space (e.g., e.g., when a game is started from the beginning, a region setting object is disposed at a default position, and when a game is resumed from the middle, a situation before a pause in a game is set based on data obtained in the log-in process), when the region setting object is disposed in the section, the processor 81 sets a user region based on the position where the region setting object is disposed, and sets the game space data De.

Next, the processor 81 obtains operation data from the left controller 3, the right controller 4, and/or the main body apparatus 2, updates the operation data Da (step S122), and proceeds to the next step.

Next, the processor 81 determines whether or not to display a map (step S123). For example, if the processor 81 determines with reference to the operation data Da that a user's operation instruction input of displaying a map has been performed, or a map image is being displayed, the result of the determination in step S123 is positive. In addition, if the processor 81 determines with reference to the operation data Da that a user operation instruction input for ending map display, or a map image is not being displayed, the result of the determination in step S123 is negative. If the processor 81 does not determine to display a map, the processor 81 proceeds to step S124. Otherwise, i.e., if the processor 81 determines to display a map, the processor proceeds to step S126.

In step S124, the processor 81 performs a player character control process, and proceeds to the next step. The player character control process in step S124 will be described below with reference to FIG. 27.

In FIG. 27, the processor 81 determines with reference to the spectating mode flag data Di whether or not a game is being currently played in the spectating mode (step S141). If the spectating mode flag is off, the processor 81 proceeds to step S142. Otherwise, i.e., if spectating mode flag is on, the processor 81 proceeds to step S151.

In step S142, the processor 81 executes a process of setting the first player character PC1's action, and proceeds to the next step. For example, the processor 81 sets the position, direction, pose, action, state, and the like of the first player character PC1 based on an operation input indicated by the operation data Da, virtual physical calculation in the game space (e.g., virtual inertia and force of gravity), and the like, and updates the player character data Dc.

Next, the processor 81 determines whether or not the first player character PC1's action of editing an object (a terrain object, decorative object, region setting object, other objects, or the like) has been set (step S143). If the action of editing an object has been set, the processor 81 proceeds to step S144. Otherwise, i.e., if the action of editing an object has not been set, the processor 81 proceeds to step S145.

In step S144, the processor 81 executes a process of editing an object in the game space, and proceeds to step S145. For example, the processor 81 edits an object to be edited in the game space based on the first player character PC1's set action, and updates the parameters of the object based on the editing to update the game space data De. In addition, the processor 81 sets the editor of the edited object to the first player character PC1, and updates the game space data De. As an example, if in step S144, a region setting object in the game space has been edited, the processor 81 updates the parameters of the region setting object based on the editing, sets a user region (e.g., first region R1) of the user operating the first player character PC1, depending on the position of the region setting object, and updates the game space data De. It should be noted that as described above, the editing of an object includes updating of various states of an object such as creation, movement, deletion, duplication, joining, changing of appearance, and embedding of information, which will not be herein described.

In step S145, the processor 81 determines whether or not to transition to the spectating mode in which an object to be spectated is spectated. For example, the processor refers to the operation data Da, and if the operation data Da indicates that an operation instruction input for transitioning to the spectating mode in which the user is a viewer and spectates an object to be spectated (e.g., in step S128 described below, an operation instruction input for setting an object to be spectated has been performed) or when a process of transitioning to the spectating mode is being executed, the result of the determination by the processor 81 in step S145 is positive. Thereafter, if the processor 81 determines to transition to the spectating mode, the processor 81 proceeds to step S146. Otherwise, i.e., if the processor 81 does not determine to transition to the spectating mode, the processor 81 proceeds to step S147.

In step S146, the processor 81 executes a spectating mode transition process, and proceeds to step S147. The spectating mode transition process in step S146 will be described below with reference to FIG. 28.

In FIG. 28, the processor 81 sets an object to be spectated that the user desires to spectate (step S161), and proceeds to the next step. For example, the processor 81 sets an object to be spectated based on an operation instruction input for selecting an object to be spectated indicated by the operation data Da, according to the method described above in the overview of game processing.

Next, the processor 81 sets a participation request for participation as a viewer in a section in which the set object to be spectated is disposed (step S162), and proceeds to the next step. For example, the processor 81 sets the communication data Db by adding information about the object to be spectated or information about a section in which the object to be spectated is disposed or the like to the participation request. Thereafter, the processor 81 transmits the participation request set in the communication data Db as transmission data, to the server 102 in a communication process in step S131 described below, thereby making a participation request.

Next, the processor 81 determines whether or not spectating in the participation request has been permitted by the server 102 (step S163). For example, the processor 81 refers to the communication data Db received from the server 102 in a communication process in step S131 described below. If server instruction data indicating the permission of spectating has been received, the result of the determination in step S163 is positive. If spectating is permitted, the processor 81 proceeds to step S164. Otherwise, i.e., if spectating is not permitted, the processor 81 proceeds to step S168.

In step S164, the processor 81 disposes the stay piece OBJp1 (see FIG. 19) in the game space instead of the first player character PC1, updates the player character data Dc and the game space data De, and proceeds to the next step. It should be noted that when the stay piece OBJp1 has already been disposed in the game space instead of the first player character PC1 before execution of step S164, step S164 may be cancelled.

Next, the processor 81 executes a process of finally determining the object to be spectated set in step S161 (step S165), and proceeds to the next step. For example, the processor 81 constructs a game space based on data indicating that spectating is permitted, and data received from the server 102 and related to a game space in a section in which the object to be spectated is disposed, and updates the game space data De. Thereafter, the processor 81 extracts the object to be spectated set in step S161 from the constructed game space, finally determines the object to be spectated in the game space, and updates the game space data De. It should be noted that the object to be spectated finally determined in step S165 may be different from the object to be spectated set in step S161. As an example, when another user corresponding to the object to be spectated set in step S161 is a viewer and is spectating another object to be spectated, the object to be spectated that is being spectated may be finally determined in step S165. In that case, in the server 102, it is determined whether or not the another object to be spectated can be spectated, and data indicating that spectating is permitted is transmitted in response to the participation request, and therefore, the object to be spectated is finally determined based on the data in step S165. In addition, when the non-displayed first player character PC1 is disposed in the section, the non-displayed first player character PC1 may be disposed in the vicinity of or the same position as the object to be spectated. In that case, the processor 81 may update the player character data Dc based on the position where the non-displayed first player character PC1 is disposed, and finally determine the non-displayed first player character PC1 as an object to be spectated.

Next, the processor 81 sets the spectating mode flag to on and updates the spectating mode flag data Di (step S166), and proceeds to the next step.

Next, the processor 81 sets a virtual camera based on the position of the object to be spectated that has been finally determined in step S165 (step S167), and ends the subroutine. For example, the processor 81 sets a virtual camera at a position a predetermined away from the object to be spectated that has been finally determined in step S165, in a predetermined direction, with the gaze point positioned at the object to be spectated, and updates the virtual camera data Dh. In addition, the processor 81 performs control to set a frame indicating the current object to be spectated (see FIGS. 20 and 21), or an outer frame indicating the current object to be spectated and an inner frame indicating another object to be spectated that is being spectated by another user corresponding to the current object to be spectated (see FIG. 22), and display the frame(s) in a rendering process in step S130 described below.

Meanwhile, in step S168, the processor 81 determines whether or not the server 102 has not permitted spectating in the participation request. For example, in a communication process in step S131 described below, the processor 81 refers to the communication data Db received from the server 102. If server instruction data indicating that the spectating has not been permitted has been received, the result of the determination in step S168 is positive. If the spectating has not been permitted, the processor 81 proceeds to step S169. Otherwise, i.e., unless the spectating has not been permitted, the processor 81 ends the subroutine.

In step S169, the processor 81 reports the user that the spectating request has not been accepted, ends the process of transitioning to the spectating mode, and ends the subroutine. For example, the processor 81 sets an image showing that the spectating request has not been accepted, and displays the image on the display 12 in a rendering process in step S130 described below. In addition, if the stay piece OBJp1 is disposed in the game space instead of the first player character PC1, the processor 81 replaces the stay piece OBJp1 with the first player character PC1, and updates the player character data Dc.

Referring back to FIG. 27, in step S147, the processor 81 determines whether or not the first player character PC1 is moving to another section. For example, the processor 81 refers to the operation data Da. If an operation instruction input for causing the first player character PC1 to move another section (e.g., a neighboring section) has been performed or the section movement process is being executed, the result of the determination in step S147 is positive. If the first player character PC1 is moving to another section, the processor 81 proceeds to step S148. Otherwise, i.e., if the first player character PC1 is not moving to another section, the processor 81 proceeds to step S149.

In step S148, the processor 81 executes a stay section movement process, and proceeds to step S149. The stay section movement process in step S148 will be described below with reference to FIG. 29.

In FIG. 29, the processor 81 sets a stay section that is a destination (step S171), and proceeds to the next step. For example, the processor 81 sets a stay section to which the first player character PC1 indicated by the operation data Da is moving, based on an operation instruction input for moving the first player character PC1.

Next, the processor 81 sets a participation request for participation as an operator in the set stay section that is a destination (step S172), and proceeds to the next step. For example, the processor 81 sets the communication data Db by adding information about, for example, a section that is a destination to which the first player character PC1 is moving as an operator, to a participation request. Thereafter, the processor 81 transmits the participation request set in the communication data Db as transmission data, to the server 102 in a communication process in step S131 described below, thereby making a participation request.

Next, the processor 81 determines whether or not participation by movement in the participation request has been permitted by the server 102 (step S173). For example, the processor 81 refers to the communication data Db received from the server 102 in a communication process in step S131 described below. If server instruction data indicating that the participation by movement has been permitted has been received, the result of the determination in step S173 is positive. If the participation has been permitted, the processor 81 proceeds to step S174. Otherwise, i.e., if the participation has not been permitted, the processor 81 proceeds to step S176.

In step S174, the processor 81 starts a stay section movement scene in which the first player character PC1 is moved to another section, and proceeds to the next step. It should be noted that in a single process in step S174, as for an action that is performed over a plurality of frames (e.g., the stay section movement scene by the first player character PC1), the processor 81 performs control for progression of the action for one frame. As a result, by repeated execution of step S174 over a plurality of frames, a series of actions related to the stay section movement scene are performed by the first player character PC1.

Next, the processor 81 sets a position where the first player character PC1 is disposed in the destination section after the end of the stay section movement (step S175), and ends the subroutine. For example, the processor 81 constructs a game space based on data indicating the above permission of participation and data related to a game space in the destination section obtained from the server 102, and updates the game space data De. Thereafter, the processor 81 sets a position where the first player character PC1 is to be disposed in the constructed game space, and updates the player character data Dc based on the setting.

Meanwhile, in step S176, the processor 81 determines whether or not participation in the participation request has not been permitted by the server 102. For example, the processor 81 refers to the communication data Db received from the server 102 in a communication process in step S131 described below. If server instruction data indicating that the participation has not been permitted has been received, the result of the determination in step S176 is positive. If the participation has not been permitted, the processor 81 proceeds to step S177. Otherwise, i.e., unless the participation has not been permitted, the processor 81 ends the subroutine.

In step S177, the processor 81 starts a stay section movement non-permission scene that reports that the first player character PC1 cannot be moved to any other section, and ends the subroutine. It should be noted that in a single process in step S177, as for an action that is performed over a plurality of frames (e.g., the stay section movement non-permission scene by the first player character PC1), the processor 81 performs control for progression of the action for one frame. As a result, by repeated execution of step S177 over a plurality of frames, a series of actions related to the stay section movement non-permission scene are performed by the first player character PC1.

Referring back to FIG. 27, the processor 81 determines whether or not the first player character PC1's action that has been set is another action. If the first player character PC1's action that has been set is another action, the processor 81 proceeds to step S150. Otherwise, i.e., if the first player character PC1's action that has been set is not another action, the processor 81 ends the subroutine.

In step S150, the processor 81 performs other control processes, and ends the subroutine. As an example, the processor 81 refers to the operation data Da. If the operation data Da indicates that an operation instruction to display and move the aiming point T has been issued, the processor 81 moves the position of the aiming point T according to the operation instruction, and provides a setting to display information of an object overlaid by the aiming point T. As another example, the processor 81 refers to the operation data Da. If the operation data Da indicates that an operation instruction to give social data (e.g., an evaluation data such as “like”) to another player character PC has been issued, the processor 81 sets an action of the first player character PC1 based on a predetermined action according to the operation instruction, updates the player character data Dc, stores the given social data into the communication data Db, and ends the subroutine.

Meanwhile, in step S151, the processor 81 executes a spectating mode process, and ends the subroutine. The spectating mode process in step S151 will be described below with reference to FIG. 30.

In FIG. 30, the processor 81 determines whether or not an object to be spectated that is being spectated in the spectating mode is spectating another object to be spectated (step S181). If the object to be spectated is not spectating any other object to be spectated, the processor 81 proceeds to the next step S182. Otherwise, i.e., if the object to be spectated is spectating another object to be spectated, the processor 81 proceeds to the next step S183.

In step S182, the processor 81 controls the virtual camera based on the user's operation input and the object to be spectated, and proceeds to step S184. For example, the processor 81 controls the position and/or orientation of the virtual camera such that the gaze point is positioned at the object to be spectated (e.g., another player character or a region setting object) as, controls the position and/or orientation of the virtual camera based on the user's operation instruction indicated by the operation data Da, and updates the virtual camera data Dh. In addition, the processor 81 performs control to set a frame indicating the current object to be spectated (see FIGS. 20 and 21), and display the frame in a rendering process in step S130 described below. It should be noted that if a non-displayed first player character PC1 is disposed for a viewer, the processor 81 may control the position and/or orientation of the virtual camera such that the gaze point is positioned at the non-displayed first player character PC1, control the positions and/or pose and orientation of the first player character PC1 and the virtual camera based on the user's operation instruction indicated by the operation data Da, and update the virtual camera data Dh.

Meanwhile, in step S183, the processor 81 controls the virtual camera based on the user's operation input and an object that is being spectated by the object to be spectated, and proceeds to step S184. For example, the processor 81 controls the position and/or orientation of the virtual camera such that the gaze point is positioned at another object to be spectated that corresponds to the object to be spectated (e.g., another player character) and that is being spectated by another user, controls the position and/or orientation of the virtual camera based on the user's operation instruction indicated by the operation data Da, and updates the virtual camera data Dh. In addition, the processor 81 performs control to set an outer frame indicating the current object to be spectated and an inner frame indicating another object to be spectated that corresponds to the current object to be spectated and that is being spectated by another user (see FIG. 22), and display the frames in a rendering process in step S130 described below.

In step S184, the processor 81 determines with reference to the operation data Da whether or not the user's operation instruction has been issued during spectating of an object to be spectated. If the user's operation instruction has been issued, the processor 81 proceeds to step S185. Otherwise, i.e., if the user's operation instruction has not been issued, the processor 81 proceeds to step S186.

In step S185, the processor 81 executes a process according to the operation instruction, and proceeds to step S186. For example, the processor 81 refers to the operation data Da. If an operation instruction to give social data (e.g., evaluation data such as “like”) to the object to be spectated has been issued, the processor 81 stores the social data given according to the operation instruction into the communication data Db.

In step S186, the processor 81 determines whether or not the object to be spectated is moving to another section. If the object to be spectated is moving to another section, the processor 81 proceeds to step S187. Otherwise, i.e., if the object to be spectated is not moving to another section, the processor 81 proceeds to step S188.

In step S187, the processor 81 executes a spectating section movement process, and proceeds to step S188. The spectating section movement process in step S187 will be described below with reference to FIG. 31.

In FIG. 31, the processor 81 sets a spectating section that is a destination (step S201), and proceeds to the next step. For example, the processor 81 sets a spectating section to which an object to be spectated is moving.

Next, the processor 81 sets a participation request for participation as a viewer in the set spectating section that is a destination (step S202), and proceeds to the next step. For example, the processor 81 adds information about, for example, a section that is a destination to which the object to be spectated is moving as a viewer to a participation request, and sets the participation request into the communication data Db. Thereafter, the processor 81 transmits the participation request set in the communication data Db as transmission data to the server 102 in a communication process in step S131 described below, thereby making a participation request.

Next, the processor 81 determines whether or not participation by movement in the participation request has been permitted by the server 102 (step S203). For example, the processor 81 refers to the communication data Db received from the server 102 in a communication process in step S131 described below. If server instruction data indicating that participation by movement has been permitted has been received, the result of the determination in step S203 is positive. If the participation has been permitted, the processor 81 proceeds to step S204. Otherwise, i.e., if the participation has not been permitted, the processor 81 proceeds to step S206.

In step S204, the processor 81 starts a spectating section movement scene showing transition to spectating in another section, and proceeds to the next step. It should be noted that in a single process in step S204, as for an action that is performed over a plurality of frames (e.g., the stay section movement scene showing transition to spectating in another section), the processor 81 performs control for progression of the scene for one frame. As a result, by repeated execution of step S204 over a plurality of frames, a series of scenes related to the stay section movement scene are performed.

Next, the processor 81 sets a spectating position in the destination section after the end of the spectating section movement (step S205), and ends the subroutine. For example, the processor 81 constructs a game space based on the data indicating the permission of participation and data received from the server 102 and related to the game space in the destination section, and updates the game space data De. Thereafter, the processor 81 sets the position of the virtual camera based on the position of the object to be spectated in the constructed game space, and updates the virtual camera data Dh.

Meanwhile, in step S206, the processor 81 determines whether or not participation by the participation request has not been permitted by the server 102. For example, in a communication process in step S131 described below, the processor 81 refers to the communication data Db received from the server 102. If server instruction data indicating that the participation has not been permitted has been received, the result of the determination in step S206 is positive. If the participation has not been permitted, the processor 81 proceeds to step S207. Otherwise, i.e., unless the participation has not been permitted, the processor 81 ends the subroutine.

In step S207, the processor 81 starts a spectating section movement non-permission scene reporting that transition to spectating in another section is not allowed, and ends the subroutine. It should be noted that in a single process in step S207, as for an action that is performed over a plurality of frames (e.g., the stay section movement non-permission scene showing that transition to spectating in another section is not allowed), the processor 81 performs control for progression of the scene for one frame. As a result, by repeated execution of step S207 over a plurality of frames, a series of scenes related to the stay section movement non-permission scene are performed.

It should be noted that in the present example, when a player object PC that is an object to be spectated has moved to another section, a request for participation in the another section as a viewer is performed, following the movement. In another example, when an object to be spectated is moved to another section, the spectating mode may be ended and transition to the stay mode. In that case, the spectating section movement process in step S187 may be cancelled, and the result of determination in step S189 described below may be positive.

Referring back to FIG. 30, in step S188, the processor 81 determines whether or not to transition to the stay mode in which the first player character PC1 is caused to stay in the game space and a game is played. As an example, the processor 81 refers to the operation data Da. If the operation data Da indicates that an operation instruction input for ending the spectating mode has been performed by the user or a process of transitioning to the stay mode is being executed, the result of the determination in step S188 is positive. As another example, the processor 81 refers to the operation data Da. If the operation data Da indicates that an operation instruction input for specifying a position where the first player character PC1 is to be caused to appear (e.g., an operation instruction input for specifying a region setting object as a position where the first player character PC1 is to be caused to appear) has been performed, the result of the determination in step S188 is positive. If the processor 81 determines to transition to the stay mode, the processor 81 proceeds to step S190. Otherwise, i.e., if the processor 81 does not determine to transition to the stay mode, the processor 81 proceeds to step S189.

In step S189, the processor 81 determines whether or not a forced exit instruction has been issued. For example, if the processor 81 has received forced exit data from the server 102 or spectating/movement has not been permitted in step S187, the result of the determination in step S189 is positive. If the forced exit instruction has been issued, the processor 81 proceeds to step S190. Otherwise, i.e., if the forced exit instruction has not been issued, the processor 81 ends the subroutine.

In step S190, the processor 81 executes a stay mode transition process, and ends the subroutine. The stay mode transition process in step S190 will be described below with reference to FIG. 32.

In FIG. 32, the processor 81 sets a stay section and a stay position where the first player character PC1 is to stay (step S211), and proceeds to the next step. As a first example, if the operation data Da indicates an operation instruction input for specifying a position where the first player character PC1 is to be caused to appear (e.g., a region setting object designated as a position where the first player character PC1 is caused to appear), the processor 81 sets the specified position as a stay position, and sets the section including the stay position as a stay section. As a second example, if a position where the first player character PC1 is to be caused to appear has not been indicated by the user's operation input, the processor 81 sets a position where the first player character PC1 has stayed before transition to the spectating mode, as a stay position, and sets the section including the stay position as a stay section.

Next, the processor 81 sets a participation request for participation as an operator at the set stay position and stay section (step S212), and proceeds to the next step. For example, the processor 81 adds information about the set stay position and stay section, information about a user account as an operator and the first player character PC1, and the like to a participation request, and sets the resultant participation request into the communication data Db. Thereafter, the processor 81 transmits the participation request set in the communication data Db as transmission data to the server 102 in a communication process in step S131 described below, thereby making a participation request.

Next, the processor 81 determines whether or not stay in the participation request has been permitted by the server 102 (step S213). For example, in a communication process in step S131 described below, the processor 81 refers to the communication data Db received from the server 102. If server instruction data indicating that the stay has been permitted has been received, the result of the determination in step S213 is positive. If the stay has been permitted, the processor 81 proceeds to step S214. Otherwise, i.e., if the stay has not been permitted, the processor 81 proceeds to step S218.

In step S214, the processor 81 executes a process of finally determining the stay section and stay position set in step S211, and proceeds to step S217. For example, the processor 81 constructs a game space based on data indicating that the stay has been permitted and data that has been received from the server 102 and is related to a game space in the stay section, and updates the game space data De. Thereafter, the processor 81 disposes the first player character PC1 in the constructed game space, and updates the player character data Dc. It should be noted that when the stay piece OBJp1 is disposed in the stay position (see FIG. 19), the processor 81 disposes the first player character PC1 instead of the stay piece OBJp1. The stay section and stay position finally determined in step S214 may be different from the stay section and stay position set in step S211. As an example, if the server 102 has issued an instruction to participate in a different stay section or stay position, the stay section or stay position may be finally determined in step S214. In that case, the server 102 determines whether or not stay in the different stay section or stay position is permitted, and transmits data indicating permission of stay in response to the participation request. Therefore, an object to be spectated is finally determined based on the data in step S214.

Meanwhile, in step S215, the processor 81 determines whether or not stay in the participation request has not been permitted by the server 102. For example, in a communication process in step S131 described below, the processor 81 refers to the communication data Db received from the server 102. If server instruction data indicating that the stay has not been permitted has been received, the result of the determination by the processor 81 in step S215 is positive. If the stay has not been permitted, the processor 81 proceeds to step S216. Otherwise, i.e., unless the stay has not been permitted, the processor 81 ends the subroutine.

In step S216, the processor 81 disposes the first player character PC1 in a management area, and proceeds to step S217. For example, the processor 81 constructs a game space based on data indicating that the stay has not been permitted and data received from the server 102 and related to a game space in a management area, and updates the game space data De. Thereafter, the processor 81 disposes the first player character PC1 in the constructed game space, and updates the player character data Dc.

In step S217, the processor 81 sets the spectating mode flag to off, updates the spectating mode flag data Di, and proceeds to the next step.

Next, the processor 81 sets a virtual camera based on the position of the first player character PC1 set in step S214 or S216 (step S218), and ends the subroutine. For example, the processor 81 sets a virtual camera at a position a predetermined distance away from the first player character PC1, in a predetermined direction, with the gaze point positioned at the first player character PC1, and updates the virtual camera data Dh. In addition, the processor 81 removes the frame indicating the object to be spectated that has been displayed in the spectating mode, and the like, and ends the process of transitioning to the stay mode.

Referring back to FIG. 26, after the player character control process in step S124, the processor 81 executes an other-player character control process (step S125), and proceeds to step S130. The other-player character control process in step S125 will be described below with reference to FIG. 33.

In FIG. 33, the processor 81 determines whether or not all of steps S222 to S226 have been completed for all other player characters PC disposed in the game space (step S221). If steps S222 to S226 have not been completed for all other player characters PC, the processor 81 proceeds to step S222. Otherwise, i.e., if steps S222 to S226 have been completed for all other player characters PC, the processor 81 ends the subroutine.

In step S222, the processor 81 chooses a player character PC for which steps S222 to S226 have not been completed, of all other player characters PC disposed in the game space, and proceeds to the next step.

Next, the processor 81 sets an action of another player character PC that is to be processed, based on the communication data Db (step S223), and proceeds to the next step. For example, the processor 81 retrieves, from the communication data Db, information about another player character PC to be processed that is received, through the server 102, from the game system 1 of another user who is operating the another player character PC, sets the another player character PC's action based on said information, and updates the other-player character data Dd. It should be noted that, in the game system 1 of the another user, processes including step S124 are performed on the player character PC operated by the another user, and said game system 1 transmits, through the server 102, communication data generated according to the result of the processes. Thereafter, in step S131 described below, data transmitted from the game system 1 of another user is received through the server 102 and stored into the communication data Db as appropriate, and in step S223 or steps S224 to S226 described below, the data thus stored in the communication data Db is used.

Next, the processor 81 determines, based on the communication data Db, whether or not the game space has been changed by an action of another player character PC to be processed (step S224). For example, the processor 81 determines whether or not the game space has been changed by another player character PC to be processed, based on information about the game space received, through the server 102, from the game system 1 of the another user operating the another player character PC. If the game space has been changed by the another user operating the another player character PC to be processed, the processor 81 proceeds to step S225. Otherwise, i.e., if the game space has not been changed by the another user operating the another player character PC to be processed, the processor 81 proceeds to step S226.

In step S225, the processor 81 performs a process of changing the game space based on an action of the another player character PC to be processed, based on the communication data Db, and proceeds to step S226. For example, the processor 81 retrieves, from the communication data Db, information about the game space changed by the action of another player character PC to be processed that has been received, through the server 102, from the game system 1 of another user operating the another player character PC. Thereafter, based on the information, the processor 81 updates a parameter at a coordinate point in the game space related to an object edited by the action of the another player character PC to be processed, to update the game space data De. As an example, if a region setting object has been edited in the game space by another player character PC's action to be processed, the processor 81 sets a user region based on the position of the region setting object, and updates the game space data De.

In step S226, the processor 81 executes other processes related to other player characters PC to be processed, and returns to and repeats step S221.

Referring back to FIG. 26, if in step S123 the processor 81 determines to display a map, the processor 81 executes a map generation process (step S126), and proceeds to the next step. For example, the processor 81 sets, into the communication data Db, transmission data for requesting the server 102 to transmit map data for displaying a map image. Thereafter, the processor 81 looks up the map data Dg to retrieve information for displaying a map received from the server 102, and based on the information, sets a virtual space for generating the section information image (a map image; see FIG. 17). It should be noted that during the period of time when step S126 is being executed, the processor 81 may dispose the stay piece OBJp1 (see FIG. 19) in the game space instead of the first player character PC1, and update the player character data Dc and the game space data De.

It should be noted that the map generation process in step S126 may be able to be executed according to the user's operation instruction input in the initial setting in step S121. In that case, based on the user's operation input instruction to select one of the sections displayed on a map, the selected section may be designated as a section in which the first player character PC1 stays for the first time. In addition, based on the user's operation input instruction to select one of the section information images displayed on a map, an in-game content corresponding to the selected section information image may be set as an object to be spectated, and the user may participate as a viewer in a section in which the object to be spectated is disposed, for the first time.

Next, the processor 81 determines with reference to the operation data Da whether or not the user's operation instruction input for selecting a section information image displayed in a map image has been performed (step S127). If the user's operation instruction input for selecting a section information image has been performed, the processor 81 ends map display, and proceeds to step S146 (see FIG. 27). Otherwise, i.e., if the user's operation instruction input for selecting a section information image has not been performed, the processor 81 proceeds to step S130.

In step S130, the processor 81 executes a rendering process, and proceeds to the next step. In the present example, the processor 81 performs control to display, on the display 12, an image of the game space or a map image based on the results of the processes in steps S122 and S127. As an example, based on the results of the above processes and the game space data De, the processor 81 sets a game space including objects, a user region, an aiming point, character information, image information, and the like. In addition, the processor 81 disposes and causes each player character PC to perform an action in the game space based on the player character data Dc and the other-player character data Dd. In addition, the processor 81 sets the position and/or orientation of a virtual camera for producing a display image based on the virtual camera data Dh to dispose the virtual camera in the game space. Thereafter, the processor 81 generates an image of the game space as viewed from the virtual camera thus set, and controls the display 12 so that the game space image is displayed on the display 12. As another example, the processor 81 performs control to dispose a virtual camera in the virtual space for generating a map image set in step S126, update the virtual camera data Dh, generates a map image of the virtual space as viewed from the virtual camera, and display the map image on the display 12. It should be noted that in any of the examples, the processor 81 may move the virtual camera in the game space based on the operation data Da, and update the virtual camera data Dh.

Next, the processor 81 performs a communication process (step S131), and proceeds to the next step. For example, the processor 81 prepares transmission data to be transmitted to the server 102, stores the transmission data into the communication data Db, and transmits the transmission data to the server 102. The processor 81 also stores received data received from the server 102 into the communication data Db. For example, the processor 81 prepares information about the action, state, and the like of a player character PC operated by the user (the first player character PC1) based on the player character data Dc, and stores the information as a portion of the transmission data into the communication data Db. In addition, the processor 81 prepares, based on the game space data De, information about an object edited by a player character PC operated by a user, and information about a user region associated with the player character PC operated by the user, as information about the game space changed by the player character PC's action, and stores the prepared information as a portion of the transmission data into the communication data Db. In addition, the processor 81 stores data indicating that social data are to be given to another player character, as a portion of the transmission data, into the communication data Db, based on data for giving social data to another player character, which is stored in the social data Df. In addition, if received data that has been received from the server 102 includes the map display information, the processor 81 updates the map data Dg using the map display information.

Next, the processor 81 determines whether or not to end the game process (step S132). In step S132, the game process is ended, for example, if a condition for ending the game process is satisfied, the user has performed an operation of ending the game process, the user has performed an operation of logging off, or the like. If the processor 81 determines not to end the game process, the processor 81 returns to and repeats step S122. Otherwise, i.e., if the processor 81 determines to end the game process, the processor 81 transmits data indicating ending (log-off) of the game to the server 102, and ends the flowchart. Following this, steps S122 to S132 are repeatedly executed until the processor 81 determines to end the game process in step S132.

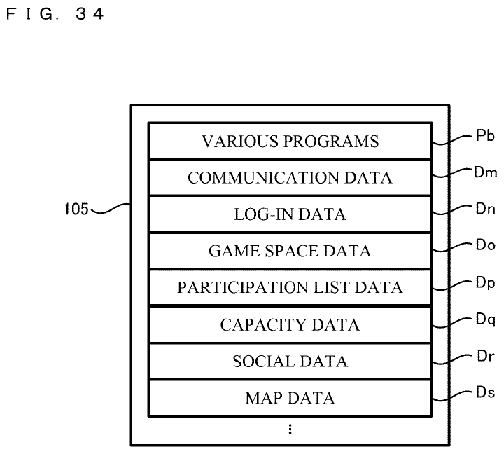

Next, data and a management program stored in the storage section 105 of the server 102 will be described with reference to FIG. 34. It should be noted that the server 102 also stores, in addition to the data illustrated in FIG. 34, data used in other processes, which will not be described in detail.

As illustrated in FIG. 27, the storage section 105 stores, in a data storage area, the communication data Dm, log-in data Dn, game space data Do, participation list data Dp, capacity data Dq, social data Dr, map data Ds, and the like. The storage section 105 also stores, in a program storage area, various programs Pb as management programs for implementing the above processes.

The communication data Dm includes received data received from each of game systems 1, and transmission data to be transmitted to each of game systems 1.

The log-in data Dn is used in a log-in process for each of the users of game systems 1. The log-in data Dn includes the ID, password, log-in/log-off state, log-in history, a game space in which a logged-in user is permitted to participate, and the like of each user, which are checked in the log-in process, and the like.

The game space data Do includes data indicating a state of each game space, and a state of the player character PC based on data related to a player character PC received from each game system 1, data related to an object and a user region in a game space received from each game system 1, and the like.

The participation list data Dp indicates a user account(s) registered for each role (a reservation holder, operator, or viewer) in each section.

The capacity data Dq indicates the capacity of each section.

The social data Dr is management data in which social data given to each user (e.g., a player character PC operated by the user) has been accumulated.

The map data Ds is for creating a section information image in a game space for each section, and indicates the position of a region setting object or a player character disposed in the game space, a reclamation value of each section, and the like.

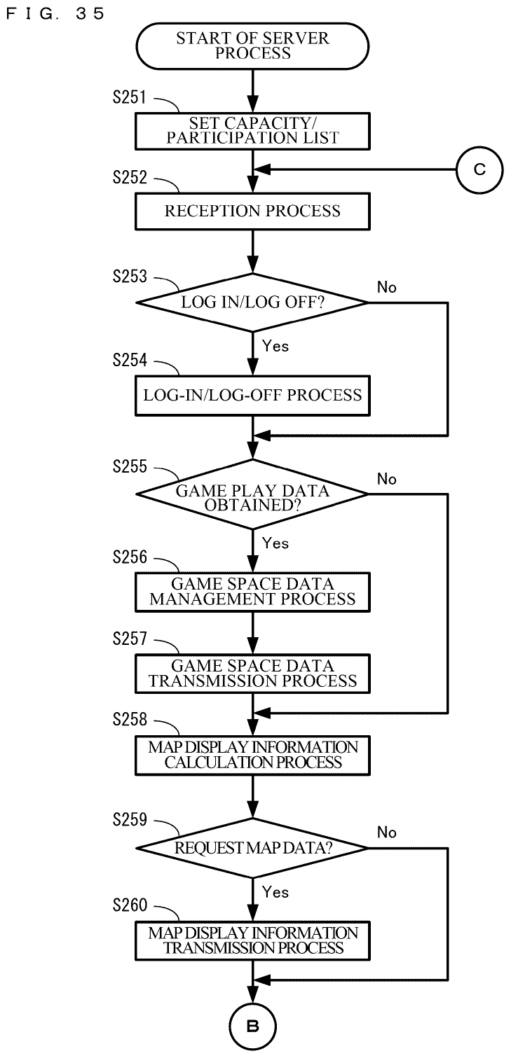

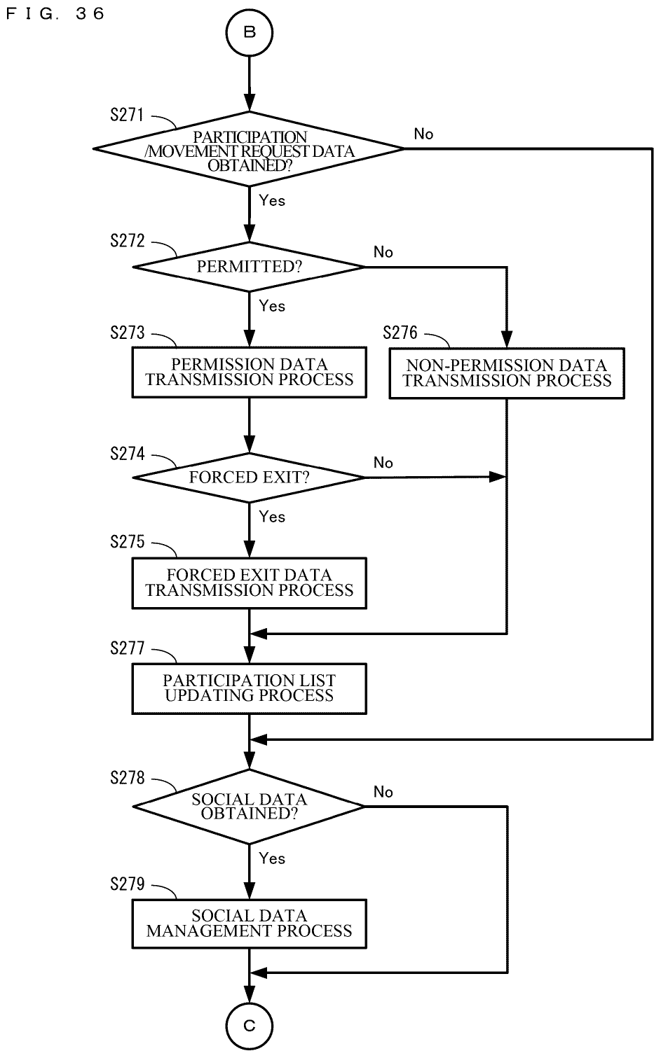

Next, processes that are executed in the server 102 will be described below with reference to FIGS. 35 and 36. Here, in the flowcharts of FIGS. 35 and 36, of the processes of the information processing system 100, the above game process in which a game space is shared by player characters PC operated by a plurality of users who play a game will be mainly described, and other processes that are not directly involved with those processes will not be described in detail. In FIGS. 35 and 36, each step that is executed by the control unit 104 is abbreviated to ‘S’.

It should be noted that the steps in the flowcharts of FIGS. 35 and 36, which are merely illustrative, may be executed in a different order, or another step may be executed in addition to and/or instead of each step, as long as a similar effect is obtained. In the present example, it is assumed that the control unit 104 (CPU) executes each step of the flowcharts. Alternatively, a portion of the steps of the flowcharts may be executed by the control unit 104 (CPU), and the other portions may be executed by a processor or dedicated circuit other than the control unit 104 (CPU). In addition, all the steps of the flowcharts may be executed by a processor or dedicated circuit other than the control unit 104 (CPU).

In FIG. 35, the control unit 104 of the server 102 sets a game space, capacity, and participation list (step S251), and proceeds to the next step. For example, the control unit 104 initially sets a game space that is divided into a plurality of sections, and updates the game space data Do. In addition, the control unit 104 sets a capacity for each section used in the game processing according to the method described in the overview of an example of game processing, and updates the capacity data Dq. In addition, the control unit 104 describes, in the participation list, a user account that is registered as a reservation holder for each section used in the game processing, according to the method described in the overview of an example of game processing, and updates the participation list data Dp.

Next, the control unit 104 executes a process of receiving transmission data transmitted from each game system 1, and storing the transmission data into the communication data Dm (step S252), and proceeds to the next step.

Next, the control unit 104 determines whether or not the data received in step S201 indicates a log-in/log-off operation (step S253). If the data is log-in data or log-off data, the control unit 104 proceeds to step S254. Otherwise, i.e., if the data is neither log-in data nor log-off data, the control unit 104 proceeds to step S255.

In step S254, the control unit 104 executes a log-in/log-off process, and proceeds to the next step. As an example, the control unit 104 determines whether or not to permit a user of a game system 1 that has transmitted log-in data to log in. If the control unit 104 determines to permit a user of a game system 1 that has transmitted log-in data to log in, the control unit 104 sets the user into a logged-in state, and updates the log-in data Dn. Thereafter, the control unit 104 sets information about log-in permission into the communication data Dm, and transmits log-in data to the game system 1 of the user. As another example, the control unit 104 sets a user of a game system 1 who has transmitted log-off data to a logged-off state, and updates the log-in data Dn. Thereafter, the control unit 104 sets, into the communication data Dm, transmission data indicating that a player character PC operated by the logged-off user is to be caused to disappear from the section, and transmits the communication data Dm to game systems 1 of users which are involved with the section in which said user has participated. In addition, the control unit 104 deletes the account of a logged-off user from the section in which the user account has been registered as an operator or viewer, reregisters the user account as a reservation holder for a section in which the user account has been temporarily removed from reservation holders, and updates the participation list data Dp.

In step S255, the control unit 104 determines whether or not the data received in step S252 is game play data. If the data received in step S252 is game play data, the control unit 104 proceeds to step S256. Otherwise, i.e., if the data received in step S252 is not game play data, the control unit 104 proceeds to step S258.

In step S256, the control unit 104 executes a game space data management process, and proceeds to the next step. For example, the control unit 104 updates a state in the game space of each section or a state of a player character PC based on data related to a player character PC or data related to an object or user region in a game space, which are indicated by the received game play data, and updates the game space data Do. It should be noted that when the state of the game space has been updated, then if there is a section in which a user region has been newly set, the control unit 104 may newly register the user account for which the user region has been set, as a reservation holder in the section, and update the participation list data Dp.

Next, the control section 104 executes a process of transmitting the game space data (step S257), and proceeds to step S258. For example, the control section 104 sets, into the communication data Dm, data related to states of a game space and a player character PC in each section that have been updated based on the game play data of each user received in step S252, as transmission data that is to be transmitted to the game system 1 of each user that is participating in game play using the section, and transmits the communication data Dm to the game systems 1 of the users.

In step S258, the control unit 104 executes a process of calculating map display information, and proceeds to the next step. For example, the control unit 104 sets the position of an in-game content in a game space of a target section based on game play data received in step S252 and the like, calculates the reclamation value of the section, and updates the map data Ds.

Next, the control unit 104 determines whether or not the data received in step S252 requests map data (step S259). If map data is requested, the control unit 104 proceeds to step S260. Otherwise, i.e., if map data is not requested, the control unit 104 proceeds to step S271 (see FIG. 36).

In step S260, the control unit 104 executes a process of transmitting the map display information, and proceeds to step S271 (see FIG. 36). For example, the control unit 104 refers to the map data Ds to obtain the map display information indicating the reclamation value of each section in the game space and the disposition state of an in-game content, sets transmission data indicating the map display information into the communication data Dm, and transmits the communication data Dm to the game system 1 of the user that has made the request.

Referring to FIG. 36, in step S271, the control unit 104 determines whether or not the data received in step S252 indicates a request for participation in a section or a request for movement to another section. If the data indicates a participation request or a movement request, the control unit 104 proceeds to step S272. Otherwise, i.e., if the data does not indicate a participation request or a movement request, the control unit 104 proceeds to step S278.

In step S272, the control unit 104 determines whether or not to accept the participation request or movement request made in step S271. For example, the control unit 104 determines whether or not to permit participation in a section by the participation request or movement to another section by the movement request based on the capacity of each section set in the capacity data Dq, according to the method described in the overview of an example of game processing. If the control unit 104 determines to accept the request, the control unit 104 proceeds to step S273. Otherwise, i.e., if the control unit 104 does not determine to accept the request, the control unit 104 proceeds to step S276.

In step S273, the control unit 104 executes a process of transmitting permission data, and proceeds to the next step. For example, the control unit 104 sets permission data indicating that participation in the section by the participation request or movement request as an operator or viewer has been permitted, into the communication data Dm, and transmits the communication data Dm to the game system 1 of the user that has made the request. In addition, the control unit 104 refers to the game space data Do, adds information about a game space in the section in which participation has been permitted to the permission data set in the communication data Dm, and transmits the communication data Dm to the game system 1. It should be noted that when the received participation request requests assignment to a section in initial setting, the control unit 104 sets permission data indicating that participation in one of the sections in which the user that has made the participation request is registered as a reservation holder, as an operator, has been permitted, and information about a game space in the section, into the communication data Dm, and transmits the communication data Dm to the game system 1 of the user that has made the request.

Next, the control unit 104 determines whether or not there is any user account that is to be forced to exit a section due to permission of participation in steps S272 and S273 (step S274). For example, if there is a user account of a viewer that is to be forced to exit a section according to the method described in the overview of an example of game processing, the result of the determination by the control unit 104 in step S274 is positive. If there is a user account that is to be forced to exit a section, the control unit 104 proceeds to step S275. Otherwise, i.e., if there is not any user account that is to be forced to exit a section, the control unit 104 proceeds to step S277.

In step S275, the control unit 104 executes a process of transmitting forced exit data, and proceeds to step S277. For example, the control unit 104 sets forced exit data indicating forced exit from a section into the communication data Dm, and transmits the communication data Dm to the game system 1 of the user that is to be forced to exit.

Meanwhile, in step S276, the control unit 104 executes a process of transmitting non-permission data, and proceeds to step S277. For example, the control unit 104 sets non-permission data indicating that participation in a section as an operator or viewer by the participation request or movement request has not been permitted, into the communication data Dm, and transmits the communication data Dm to the game system 1 of the user that has made the request.

In step S277, the control unit 104 executes a process of updating the participation list, and proceeds to step S278. For example, the control unit 104 registers/deletes a user account registered in each section for each role (a reservation holder, operator, or viewer) according to the method described in the overview of an example of game processing, based on permission of participation in the section in step S273 or forced exit from the section in step S275, and updates the participation list data Dp. In addition, if there is a user account for which a predetermined period of time (e.g., an hour) has passed since the user account was registered as a viewer, the control unit 104 cancels registration of the user account as an operator, reregisters the user account as a reservation holder in the section in which the user account has been temporarily removed from reservation holders, and updates the participation list data Dp.

In step S278, the control unit 104 determines whether or not the data received in step S252 indicates that social data is to be given. If the data indicates that social data is to be given, the control unit 104 proceeds to step S279. Otherwise, i.e., if the data does not indicate that social data is to be given, the control unit 104 returns to and repeats step S252 (see FIG. 35).

In step S279, the control unit 104 executes a social data management process, and returns to and repeats step S252 (see FIG. 35). For example, the control unit 104 updates the social data Dr based on a content to which the received social data is to be given (a player character PC to which the type of social data is given, etc.). Thereafter, the control unit 104 sets transmission data indicating that social data is to be given to an entity (a player character PC to which social data is to be given) into the communication data Dm, and transmits the social data to the game system 1 of the user that is the entity to which social data is to be given (the user operating the player character PC to which social data is to be given).

It should be noted that the processing executed in the server 102 may be carried out using a plurality of server machines, or a plurality of server resources provided in at least one server machine. As an example, the processing may be executed using a plurality of section server machines (or a plurality of section server resources) that manage game spaces in respective sections, and a management server machine (or management server resources) related to the plurality of section server machines. In that case, a request for participation in a section is transmitted from the game system 1 to a management server machine, and the management server machine checks the situation of participation in a related section server machine. Thereafter, if participation in a section is allowed, the management server machine transmits key data that allows participation in the section to the game system 1 that has requested the participation. By the game system 1 accessing the section server machine managing the section using the key data, game play using the section is allowed. In that case, capacity management for each section may be performed by one or both of the management server machine (or management server resources) and the respective section server machine (or section server resources).

In addition, at least a portion of the processes executed by the game system 1 may be executed in the server 102 or other devices. In addition, at least a portion of the processes executed by the server 102 may be executed by the game system 1 or other devices.

Thus, in the present example, when the number of operators that cause a player character to enter and participate in a game session (section) and viewers that spectate and participate in a game session (section) increases, the server 102 manages users that are to participate in a game session, and therefore, can determine a user that is to participate in a game session based on the order of priority or the like.

In the present example, examples have been described in which data is managed for a player character PC, a relevant process is executed for an action performed by a player character PC, and section control is performed for a player character PC. These examples are equivalent to the case in which these processes are executed for the user that operates the player character PC (more specifically, a game account, or a user ID that is an identifier assigned to the user). In addition, examples have been described in which data is managed for a user (account), a relevant process is executed for a user, and capacity control is performed for a user. These examples are equivalent to the case where these processes are executed for a player character PC operated by the user. For example, in the present example, the user may designate either a game account or a player character as an object to be spectated.

It should be noted that in another example, the function of refusing spectating from other users may be provided. In that case, user accounts for which spectating is refused may be managed in the server 102. As a result, when a participation request is made in which an in-game content such as a player character PC or a region setting object related to such a user account is designated as an object to be spectated, the above function may be carried out by the server 102 determining that the participation request is not accepted.

In addition, in the present example, a game is used in which an in-game content such as a player character PC or a region setting object A is disposed in one of sections (game sessions) set in a game space, and the game space in the section is edited. A game played in a game session is not particularly limited. For example, a competitive game may be played between a plurality of player characters as an in-game content in one of a plurality of game sessions.

In addition, although in the present example, an object (a terrain object, a decorative object) is edited by a player character PC's action, an object may be edited according to a user's operation without through a player character PC. For example, by a user performing a user instruction operation of directly specifying a position (coordinate point) in the game space, an object associated with the user may be edited at the specified position. In that case, a player character operated by the user does not need to appear in the game space, and the editor of the object may be registered according to the user's operation instruction to perform a predetermined action on an object directly chosen by the user.

The game system 1 may be any suitable apparatus, including handheld game apparatuses, personal digital assistants (PDAs), mobile telephones, smartphones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example. In addition, the example operation button used in the above operation is merely illustrative, and the above examples may be implemented using other operation buttons. In addition, there may be a plurality of operation buttons having a similar function (e.g., an operation of giving a high rating (“like”) may be implemented even by pressing down any of the operation buttons 33 to 36 (cross button) or pressing down the operation button 53 (A-button).

The above programs may be supplied to the game system 1 or the server 102 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a” “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is applicable as a game system, management program, server, game processing method, and the like that allows contents reported by a user not to be seen from the user.

What is claimed is:

1. A game system comprising:
at least one server configured to manage a game session; and
a plurality of information processing terminals configured to connect to the server, wherein
accounts related to the respective information processing terminals are caused to participate in the game session, and a game is played between the accounts,
the server is configured to
in response to a participation request received from the information processing terminal, cause the account related to the information processing terminal to participate in the game session as at least one of an operator that operates a player object related to the account in the game and a viewer that at least views an in-game content in the game,
transmit game information about a state of the game to the information processing terminal related to the account that is participating in the game session, and
update the game information based on update information received from the information processing terminal,
a first information processing terminal of the plurality of information processing terminals is configured to
transmit, to the server, data including a first account related to the first information processing terminal as a first participation request for participation in the game session as the operator, based on a first operation input of a user,
based on a second operation input for designating an in-game content included in one of a plurality of the game sessions, transmit, to the server, data including the first account as a second participation request for participation as the viewer in the game session including the in-game content,
when the first account is participating in the game session as the operator,
generate a game space including a first player object related to the first account, based on the game information,
perform first virtual camera control to control a virtual camera in the game space, based on a position of the first player object, and
transmit, to the server, the update information based on the state of the game space, and
when the first account is participating in the game session as the viewer,
generate a game space including the in-game content designated by the second operation input, based on the game information,
update a state of the in-game content based on the game information, and
perform second virtual camera control to control the virtual camera in the game space, based on a position of the in-game content designated by the second operation input, and
the server is further configured to
when the sum of the number of accounts that are participating in the game session as the operator and the number of accounts that are participating in the game session as the viewer satisfies a condition, cause at least one of the accounts that are participating in the game session as the viewer to exit the game session, and stop transmitting the game information to the information processing terminal related to the exited account.

2. The game system according to claim 1, wherein
the server is further configured to
in response to reception of the first participation request from a second account related to a second information processing terminal of the plurality of information processing terminals, cause the second account to participate in the game session as the operator, and
the first information processing terminal is configured to
based on the second operation input of a user designating the second account or a second player object related to the second account, transmit, to the server, the second participation request for participation as the viewer in the game session including the second player object.

3. The game system according to claim 1, wherein
the server is further configured to manage a first and a second game session of the plurality of game sessions,
the management of the second game session includes causing the first account to participate in the second game session as the viewer in response to reception of the second participation request for participation in the second game session as the viewer from the first account participating in the first game session as the operator, and
the management of the first game session includes causing the first account to participate in the first game session as the operator in response to reception of the first participation request for participation in the first game session as the operator from the first account participating in the second game session as the viewer.

4. The game system according to claim 3, wherein
the management of the first game session further includes
storing the number of the accounts that are participating in the first game session as the operator and the number of the accounts that are participating in the first game session as the viewer, and
not reducing the number of the accounts that are participating in the first game session as the operator in response to participation of the account that has been participating in the first game session as the operator, in the second game session as the viewer.

5. The game system according to claim 4, wherein
the management of the first game session further includes reducing the number of the accounts that are participating in the first game session as the operator in response to passage of a period of time after participation of the first account in the second game session as the viewer.

6. The game system according to claim 3, wherein
the first information processing terminal is further configured to
when the first account participates in the second game session as the viewer from the first game session in which the first account has been participating as the operator, dispose a first object having an appearance different from that of the first player object at a position based on a position of the first player object in the game space in the first game session, and transmit, to the server, the update information including first object position information about the position of the first object, and
when a second account related to a second information processing terminal of the plurality of information processing terminals participates in the first game session as the operator, generate the game space including the first object at a position based on the object position information.

7. The game system according to claim 6, wherein
the first information processing terminal is further configured to
when the first account participates in the first game session as the operator from the second game session in which the first account has been participating as the viewer, generate the game space in which the first player object is disposed at a position based on the first object position information instead of the first object.

8. The game system according to claim 6, wherein
the second information processing terminal is further configured to limit changing of a state of the first object based on the user's operation input.

9. The game system according to claim 3, wherein
the management of the first game session includes causing the first account to participate in the first game session as the operator when the management of the second game session causes the first account to exit the second game session based on satisfaction of the condition by the second game session after causing the first account to participate in the second game session as the viewer.

10. The game system according to claim 1, wherein
the server is further configured to, when the condition is satisfied, determine the account that is to exit the game session, based on the length of a period of time that has passed since the participation as the viewer in the game session for which the condition is satisfied.

11. The game system according to claim 1, wherein
the first information processing terminal is configured to, when the first account is participating in the first game session as the operator, dispose a second object in the game space based on the user's third operation input, and transmit, to the server, the update information including second object position information about a position of the second object, and
the server is further configured to
store the first account as a disposer in association with the first game session based on reception of the update information including the second object position information, and
when the first game session satisfies the condition due to reception of the second participation request for participation in the first game session as the viewer from the first information processing terminal related to the first account stored as the disposer, cause the account that is not stored as the disposer and is participating in the first game session as the viewer to exit the first game session.

12. The game system according to claim 1, wherein
the first information processing terminal is configured to
when the first account is participating as the operator in a first game session of the plurality of game sessions, dispose a second object in the game space based on the user's third operation input, and transmit, to the server, the update information including second object position information about a position of the second object, and
when the first account is participating in the first game session as the viewer in response to the user's second operation input for designating the second object, transmit, to the server, the first participation request for participation in the first game session as the operator in response to the user's fourth operation input, and
the server is configured to cause the first account to participate in the first game session as the operator in response to the first participation request transmitted in response to the fourth operation input.

13. The game system according to claim 1, wherein
the first information processing terminal is configured to, when the first account is participating in the first game session as the operator, dispose a second object in the game space based on the user's third operation input, and transmit, to the server, the update information including second object position information about a position of the second object, and
a second information processing terminal of the plurality of information processing terminals is configured to, when a second account related to the second information processing terminal participates in the first game session as the operator, transmit, to the server, the second participation request for participation as the viewer in a game session in which the first account is participating as the operator, based on the user's fifth operation input with respect to the second object.

14. The game system according to claim 1, wherein
the first information processing terminal is configured to, when the first account is participating in the first game session as the operator, dispose a second object in the game space based on the user's third operation input, and transmit, to the server, the update information including second object position information about a position of the second object, and
a second information processing terminal of the plurality of information processing terminals is configured to
when a second account related to the second information processing terminal participates in the first game session as the operator, obtain an item related to the second object based on the user's fifth operation input with respect to the second object, and
transmit, to the server, the second participation request for participation as the viewer in a game session in which the first account is participating as the operator, based on the user's sixth operation input for using the obtained item.

15. The game system according to claim 1, wherein
the first information processing terminal is further configured to transmit, to the server, the second participation request for designating a second account related to a second information processing terminal of the plurality of information processing terminals, and
the server is configured to, when the second account is participating as the viewer in a third game session of the plurality of game sessions, cause the first account to participate in the third game session as the viewer in response to the second participation request.

16. A non-transitory computer-readable storage medium having stored therein a management program that when executed in a game system including at least one server configured to manage a game session, and a plurality of information processing terminals configured to connect to the server, wherein accounts related to the respective information processing terminals are caused to participate in the game session, and a game is played between the accounts, causes one or more processors of the server to execute operations comprising:
in response to a participation request received from the information processing terminal, causing the account related to the information processing terminal to participate in the game session as at least one of an operator that operates a player object related to the account in the game and a viewer that at least views an in-game content in the game;
transmitting game information about a state of the game to the information processing terminal related to the account that is participating in the game session;
updating the game information based on update information received from the information processing terminal; and
when the sum of the number of accounts that are participating in the game session as the operator and the number of accounts that are participating in the game session as the viewer satisfies a condition, causing at least one of the accounts that are participating in the game session as the viewer to exit the game session, and stopping transmitting the game information to the information processing terminal related to the exited account.

17. A server for connecting to a plurality of information processing terminals and managing a game session, comprising at least one processor, the processor being configured to:
cause accounts related to the respective information processing terminals to participate in the game session, and execute a game between the accounts,
in response to a participation request received from the information processing terminal, cause the account related to the information processing terminal to participate in the game session as at least one of an operator that operates a player object related to the account in the game and a viewer that at least views an in-game content in the game;
transmit game information about a state of the game to the information processing terminal related to the account that is participating in the game session;
update the game information based on update information received from the information processing terminal; and
when the sum of the number of accounts that are participating in the game session as the operator and the number of accounts that are participating in the game session as the viewer satisfies a condition, cause at least one of the accounts that are participating in the game session as the viewer to exit the game session, and stop transmitting the game information to the information processing terminal related to the exited account.

18. A game processing method performed on a game system including at least one server configured to manage a game session, and a plurality of information processing terminals configured to connect to the server, wherein accounts related to the respective information processing terminals are caused to participate in the game session, and a game is played between the accounts, the game processing method comprising:
causing the server to
in response to a participation request received from the information processing terminal, cause the account related to the information processing terminal to participate in the game session as at least one of an operator that operates a player object related to the account in the game and a viewer that at least views an in-game content in the game,
transmit game information about a state of the game to the information processing terminal related to the account that is participating in the game session, and
update the game information based on update information received from the information processing terminal,
causing a first information processing terminal of the plurality of information processing terminals to
transmit, to the server, data including a first account related to the first information processing terminal as a first participation request for participation in the game session as the operator, based on a first operation input of a user,
based on a second operation input for designating an in-game content included in one of a plurality of the game sessions, transmit, to the server, data including the first account as a second participation request for participation as the viewer in the game session including the in-game content,
when the first account is participating in the game session as the operator,
generate a game space including a first player object related to the first account, based on the game information,
perform first virtual camera control to control a virtual camera in the game space, based on a position of the first player object, and
transmit, to the server, the update information based on the state of the game space, and
when the first account is participating in the game session as the viewer,
generate a game space including the in-game content designated by the second operation input, based on the game information,
update a state of the in-game content based on the game information, and
perform second virtual camera control to control the virtual camera in the game space, based on a position of the in-game content designated by the second operation input, and
further causing the server to
when the sum of the number of accounts that are participating in the game session as the operator and the number of accounts that are participating in the game session as the viewer satisfies a condition, cause at least one of the accounts that are participating in the game session as the viewer to exit the game session, and stop transmitting the game information to the information processing terminal related to the exited account.
